(19) United States
(12) Patent Application Publication
(10) Pub. No.: US 2017/0010941 A1
(43) Pub. Date: Jan. 12, 2017

(54) METHOD FOR ADJUSTING BACKUP SCHEDULE FOR VIRTUAL COMPUTER

(71) Applicant: HITACHI, LTD., Tokyo (JP)

(72) Inventors: Keita SHIMADA, Tokyo (JP); Hironori EMARU, Tokyo (JP)

(73) Assignee: HITACHI, LTD., Tokyo (JP)

(21) Appl. No.: 15/121,112

(22) PCT Filed: May 30, 2014
(86) PCT No.: PCT/JP2014/064363

§ 371 Date: Aug. 24, 2016

(51) Int. Cl. G06F 11/14

(52) U.S. Cl. CPC G06F 11/1461; G06F 11/1464; G06F 2201/84

(57) ABSTRACT

The present invention provides a method for adjusting a backup schedule for a virtual computer comprising a plurality of virtual computers managed by a managing computer, the method including: a first step of generating a policy on the basis of user condition information including a time limit condition in a virtual computer restoring process and of which the input is accepted on the basis of first right, and IT infrastructure condition information including a condition limiting the amount of use of resources allocated to the virtual computer and of which the input is accepted on the basis of second right different from the first right; and a second step of adjusting the backup schedule for the virtual computer on the basis of the policy and operating information indicating an operating state of the virtual computer.

### TECHNICAL FIELD

The present invention relates to technique for a management server to generate and adjust a backup schedule of a virtual machine (a virtual server).

### BACKGROUND ART

Currently, service using virtualization technology such as IaaS (Infrastructure as a Service) and PaaS (Platform as a Service) gains power, system architecture has been enabled by simply provisioning a virtual machine (VM) in which a business system, middleware, OS and others are set beforehand, and time required for system architecture can be reduced in comparison with conventional type system architecture.

Further, the abovementioned IaaS adopts such a mode of the operation of the VM as a tenant manager freely executes VM provisioning using provided IT resources by dividing the IT resources virtualized in the shape of a tenant into plural pieces and transferring each piece to the tenant manager so as to effectively utilize the IT resources. Hereby, a conventional type IT infrastructure administrator has been required to administrate the operation of an IT infrastructure, providing IT resources required for IaaS to a tenant manager.

In the conventional type system architecture, the IT infrastructure administrator strictly sets resources required for backup and a backup schedule beforehand on the basis of the business volume of a system and an operating schedule of the business system and after the operation of the system is started, the IT infrastructure administrator has not been required to change the design of the backup schedule and others. Therefore, an initial design cost was high, but a cost due to a subsequent design change could be inhibited.

However, in environment using virtualization technology such as IaaS, it turned out that a tenant manager freely executed VM provisioning, a change of the configuration of the VM, backup setting and others in provided resources. Therefore, a backup schedule strictly set to an IT infrastructure by the conventional type IT infrastructure administrator beforehand might not be optimum setting. Moreover, as in the virtualization environment, a great number of VMs existed and resources might be shared among the plural VMs, design costs when the tenant manager tried to set a backup schedule of each of the great number of VMs the configuration of which is dynamically changed, also adding the shared resources became huge.

### CITATION LIST

### Patent Literature

Patent Literature 1: Japanese Patent Application Publication No. 2005-190259

### SUMMARY OF INVENTION

### Technical Problem

For a method of managing backup data by setting a backup schedule on the basis of a warranty period of backup, a cycle of backup and the number of backup generations respectively set by the user, technique disclosed in the patent literature 1 is proposed.

However, in the technique disclosed in the patent literature 1, was difficult for the user to generate a backup schedule in consideration of an operating state of a business system and a virtual machine respectively to be backed up and a situation of IT resources shared among plural business systems.

Further, for the user who utilizes the abovementioned IaaS and PaaS, as a cost for management of the user increases when the user also manages the configuration of an IT infrastructure that supports the business system and the virtual machine except the business system and the virtual machine respectively managed by the user itself, it is desired that the user has only to input only the minimum requirements without being conscious of the configuration of the IT infrastructure.

### Solution to Problem

The present invention is based upon a method of generating a backup schedule for indicating scheduled time at which the backup of a virtual computer out of plural virtual computers managed by a managing computer is to be executed, wherein the method includes a first step of generating a policy which is a rule for executing backup on the basis of user condition information which includes a condition for limiting in a virtual computer restoring process based upon a backup and the input of which is accepted based upon first authority, and IT infrastructure condition information which includes a condition for limiting the amount of use of resources allocated to the virtual computer and the input of which is accepted based upon second authority different from the first authority, and a second step of adjusting a backup schedule of the virtual computer on the basis of the policy and operational information indicating an operating state of the virtual computer.

### Advantageous Effects of Invention

According to one embodiment of the present invention, in environment in which plural virtual servers share IT resources, the ready generation of a backup schedule of the virtual server is enabled and leads to the reduction of running costs.

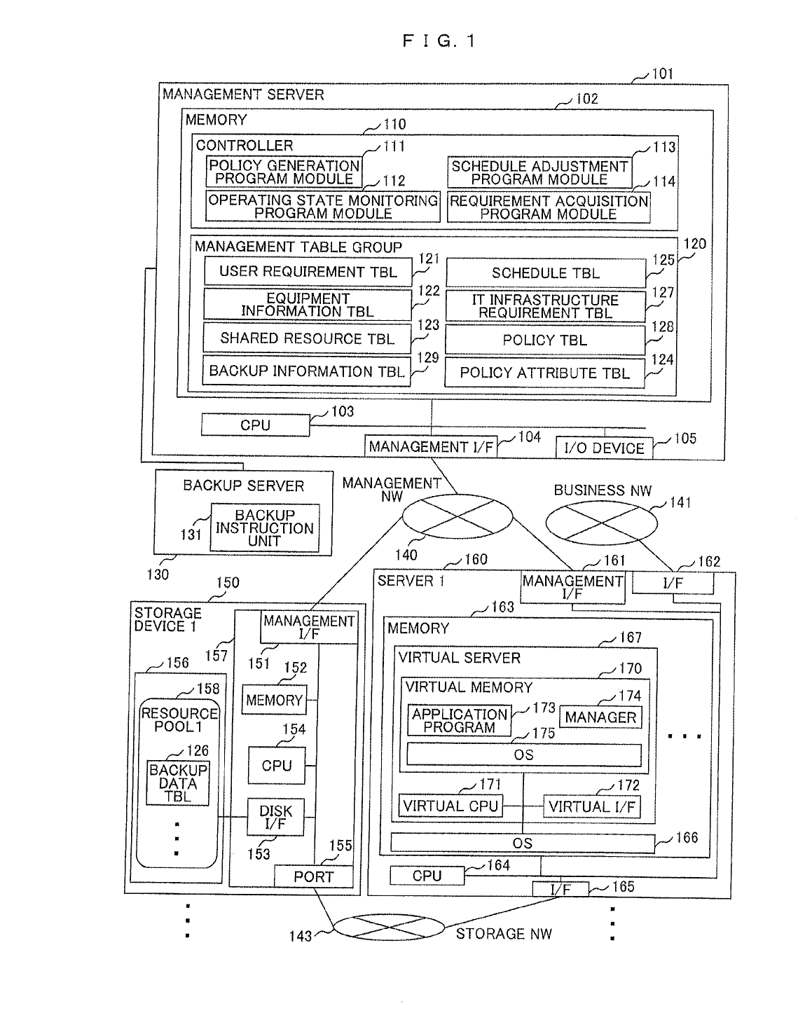

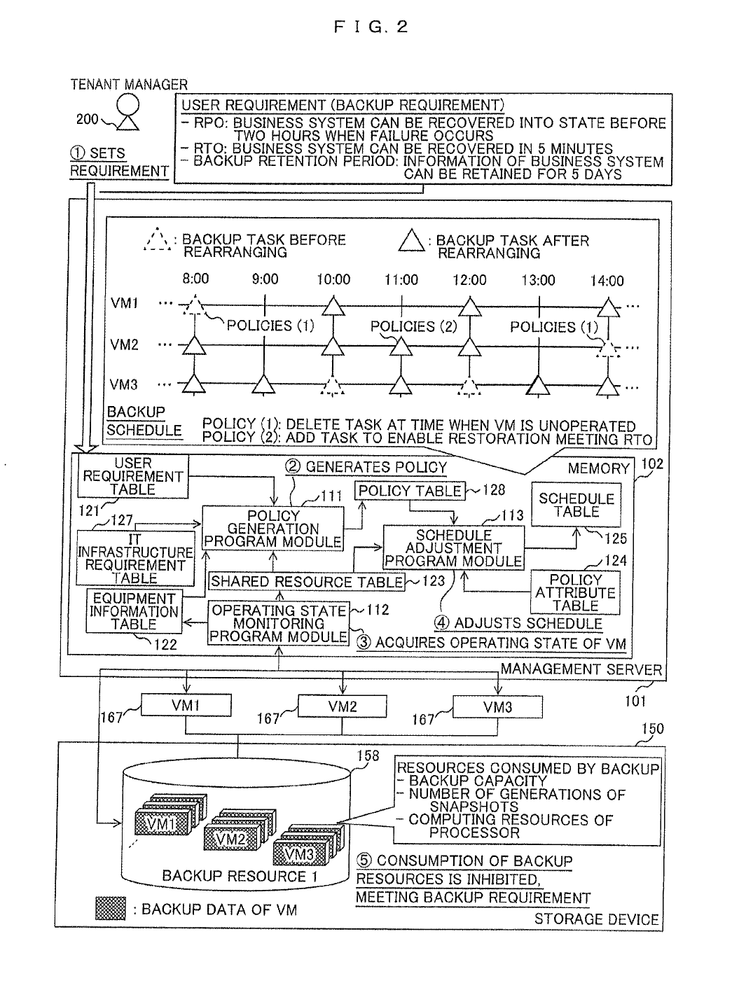

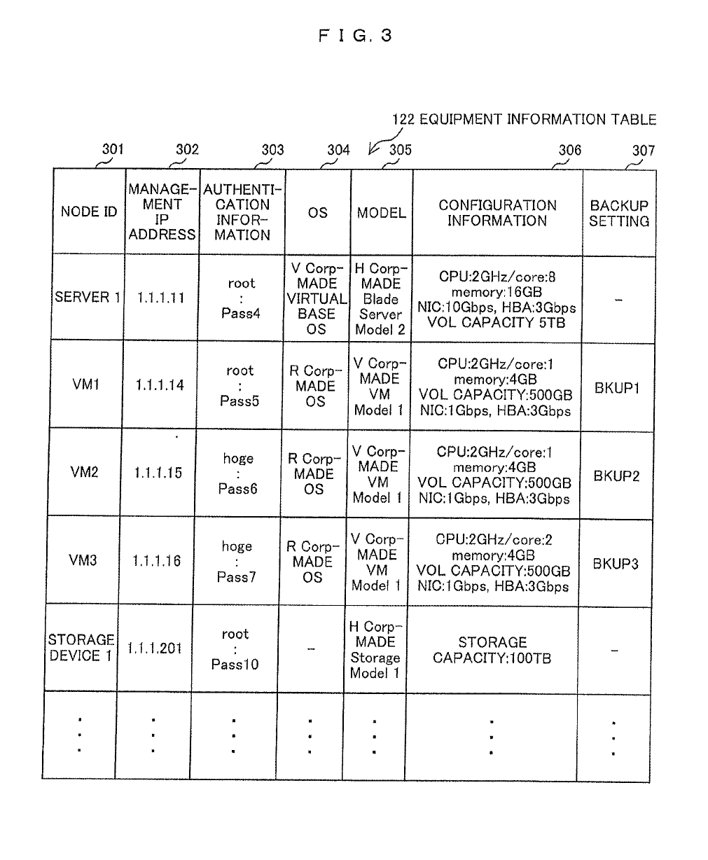

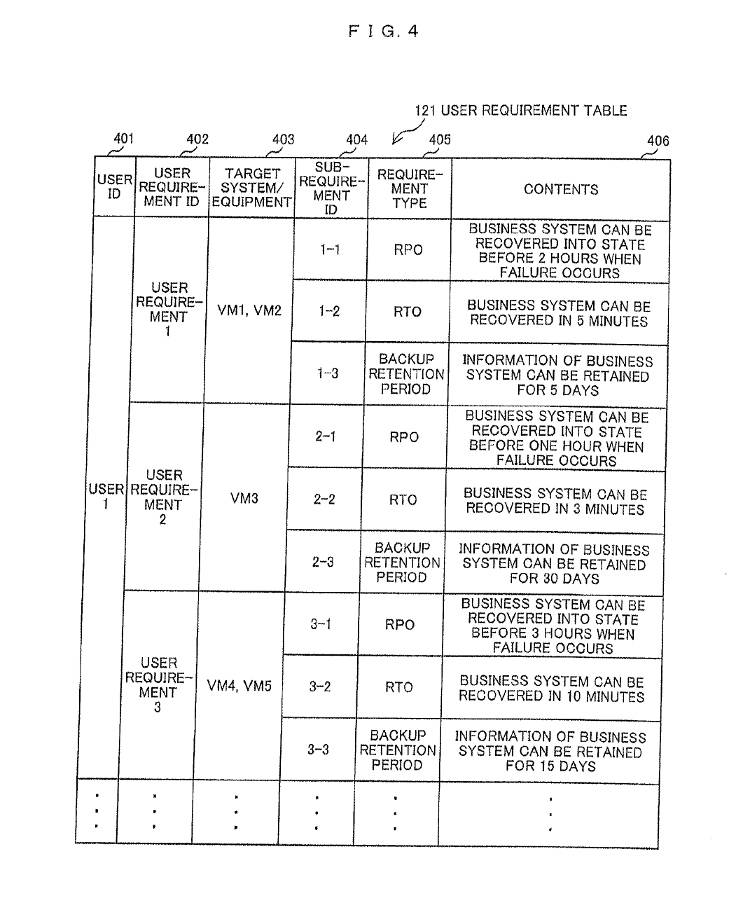

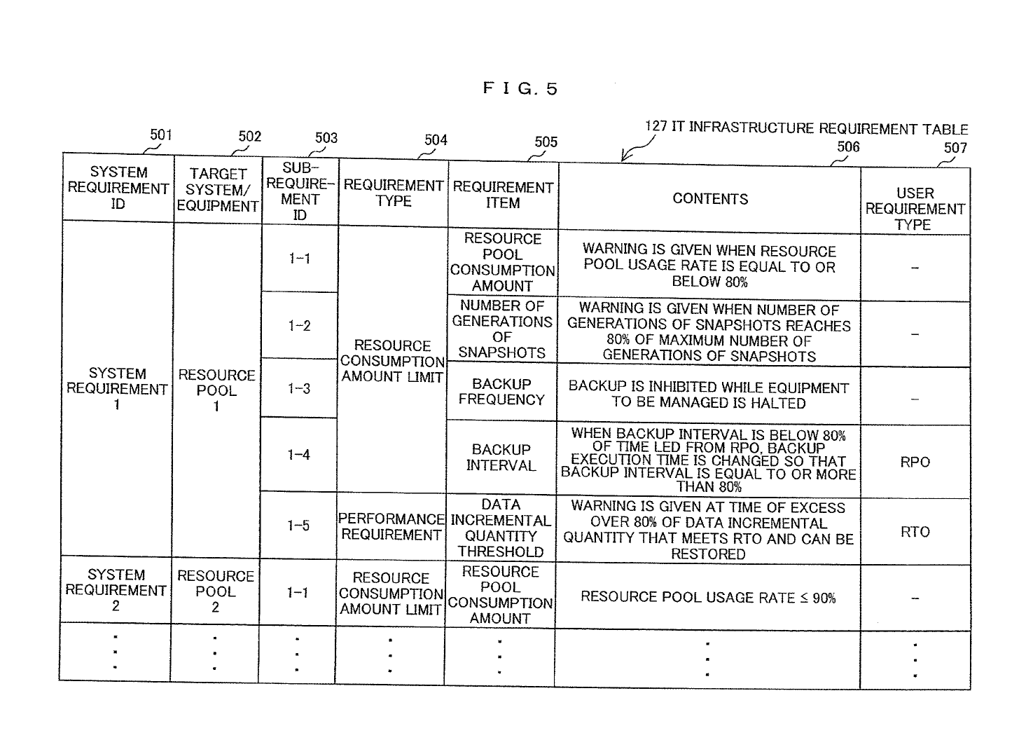

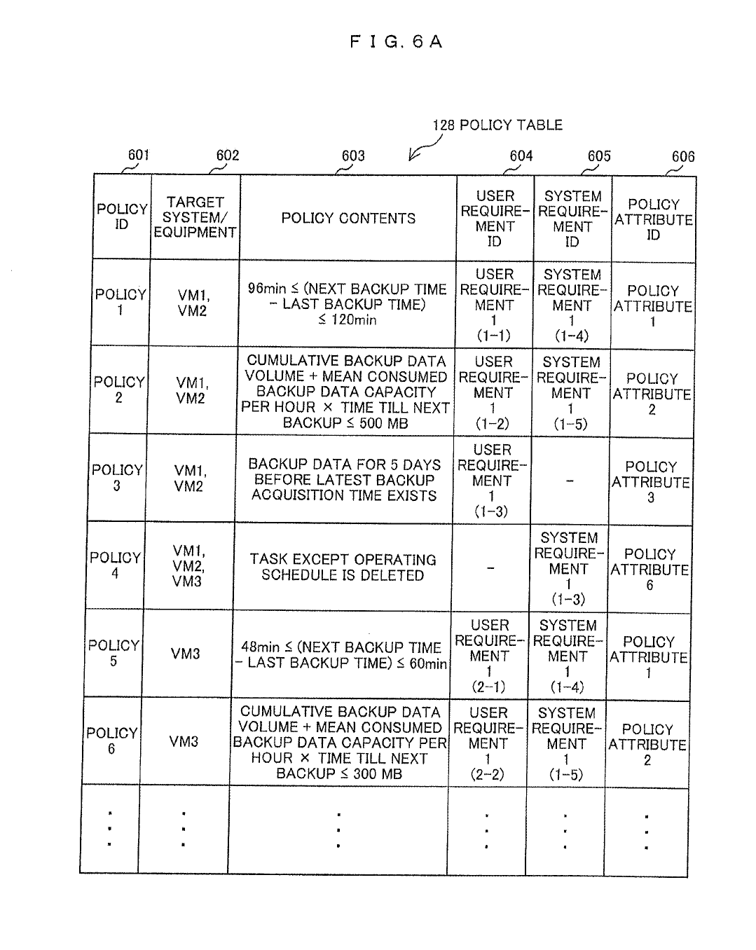

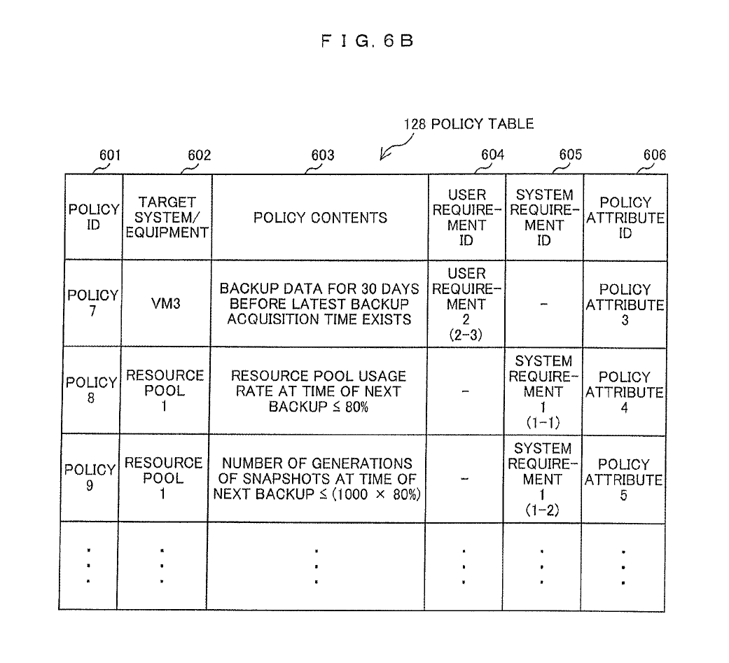

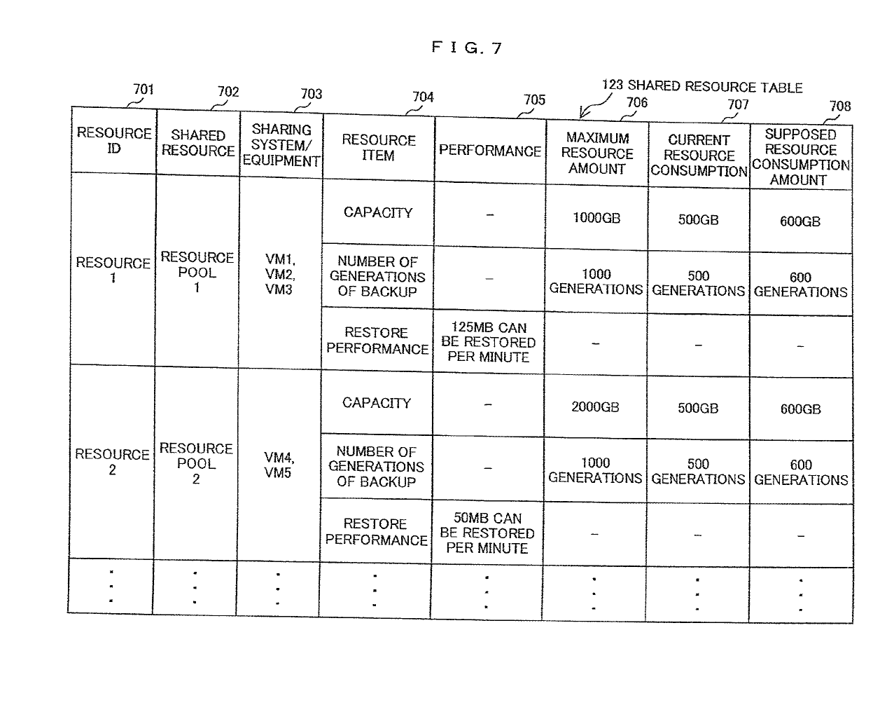

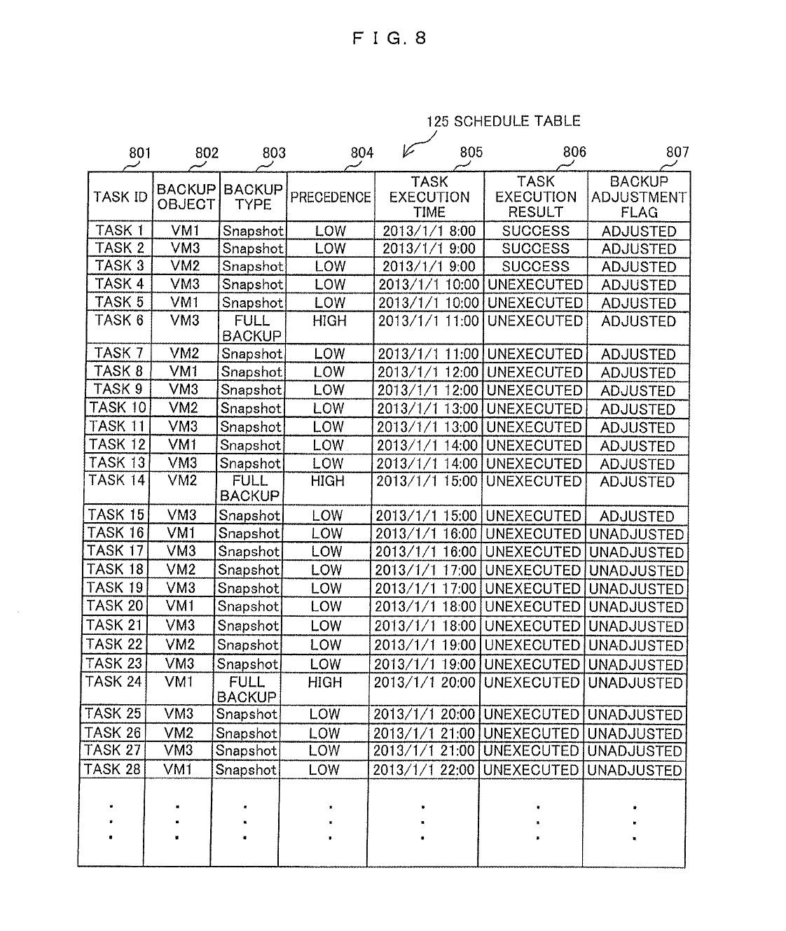

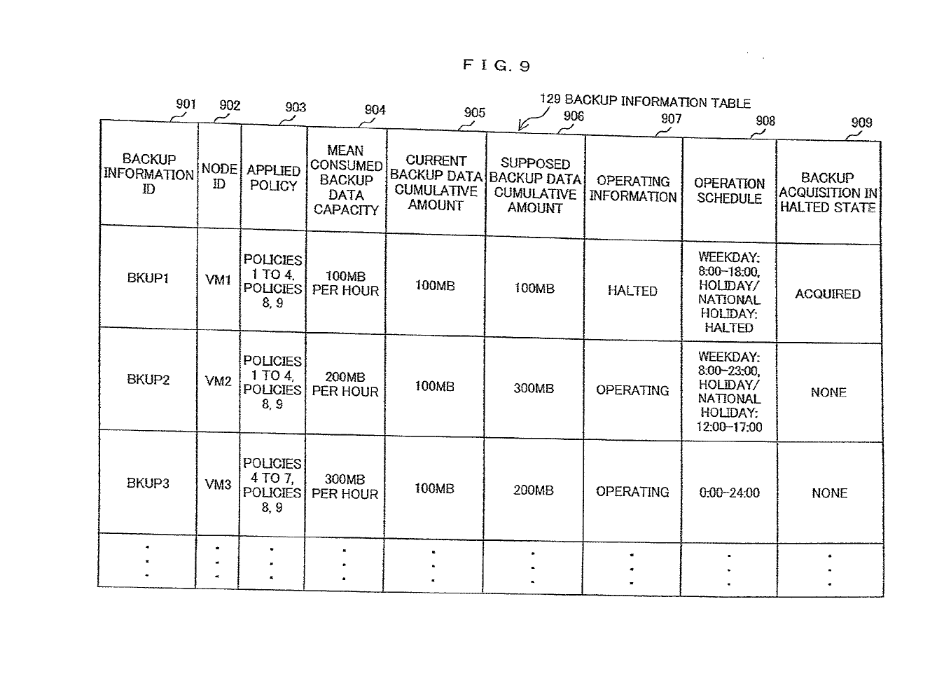

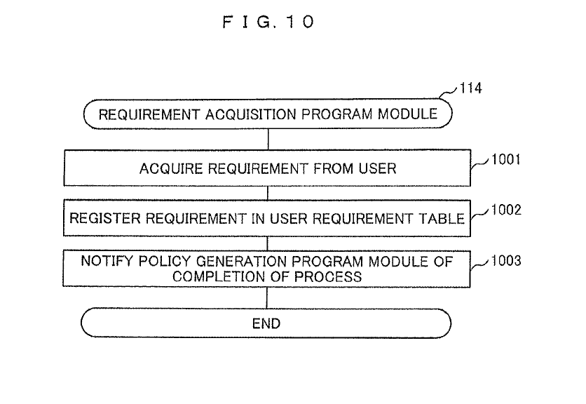

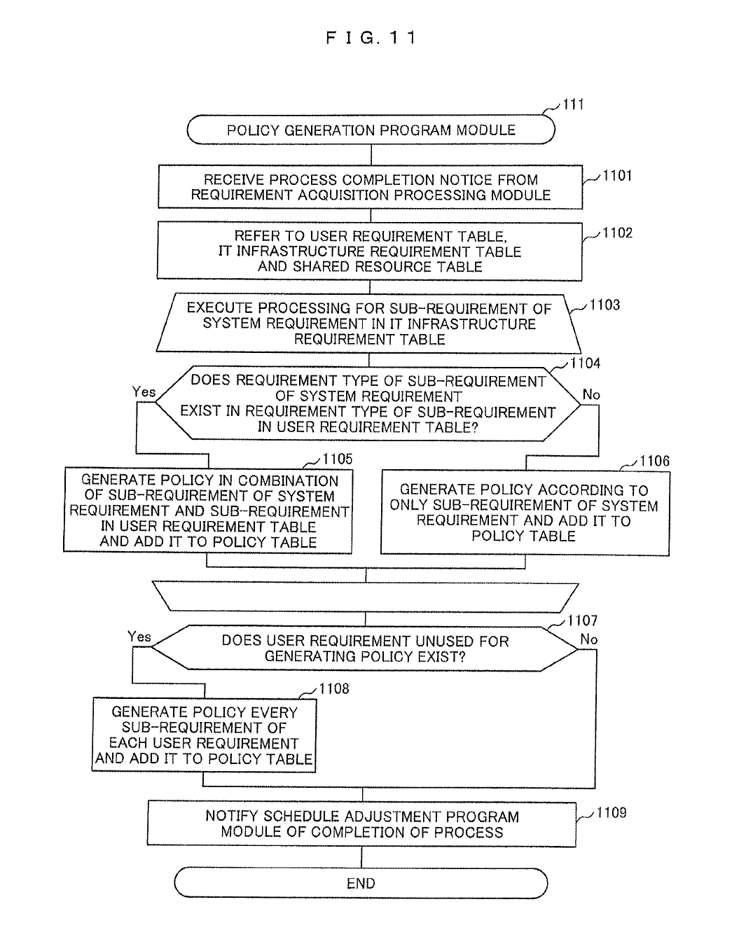

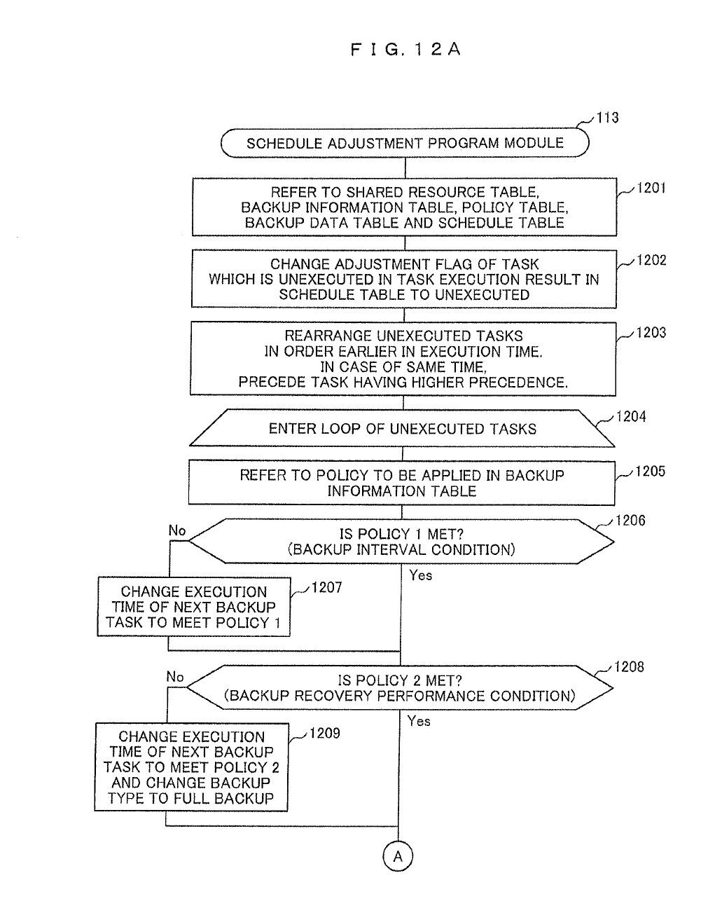

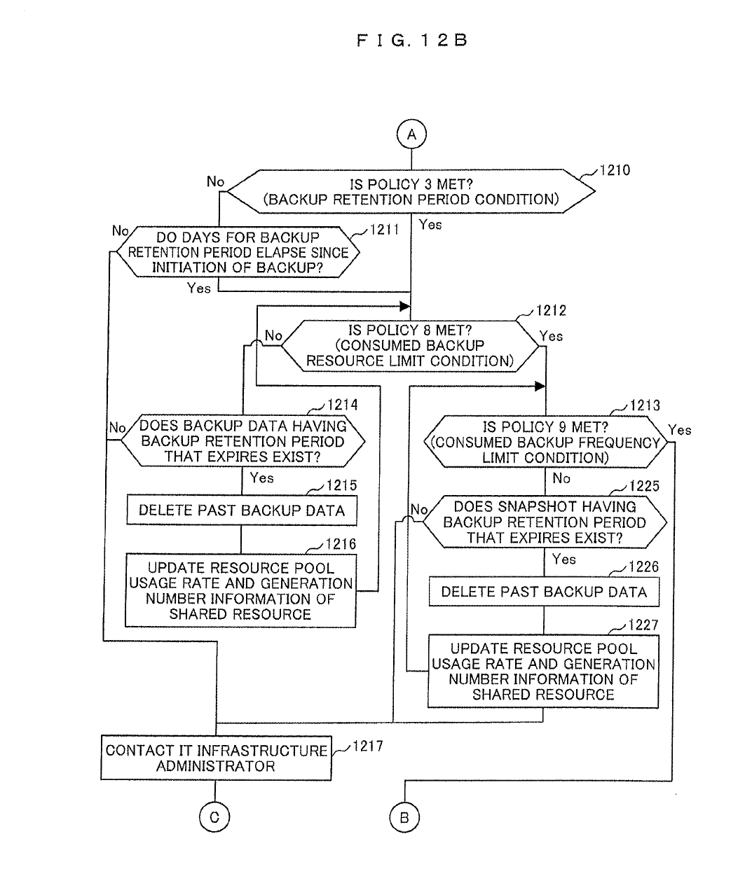

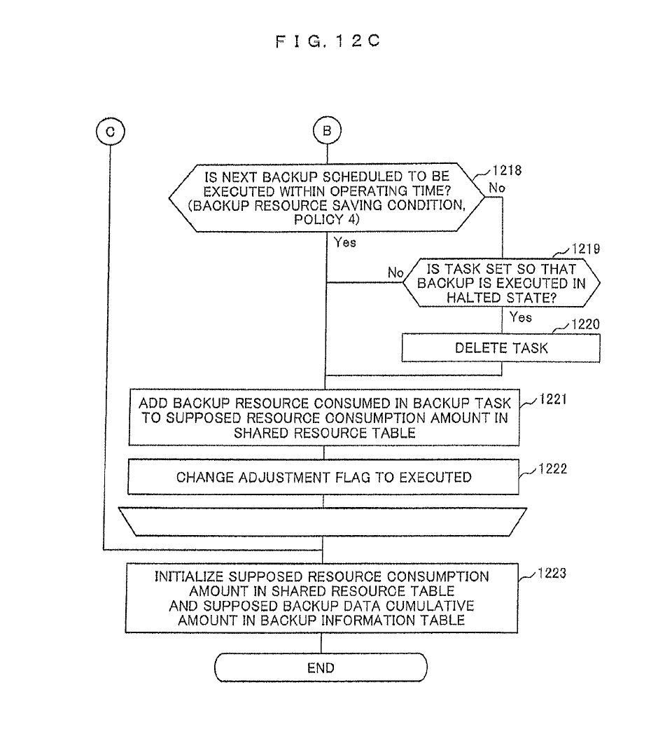

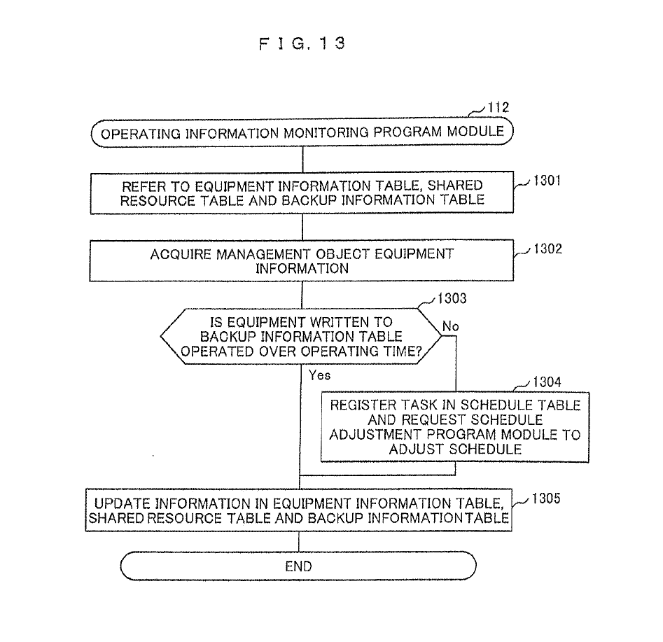

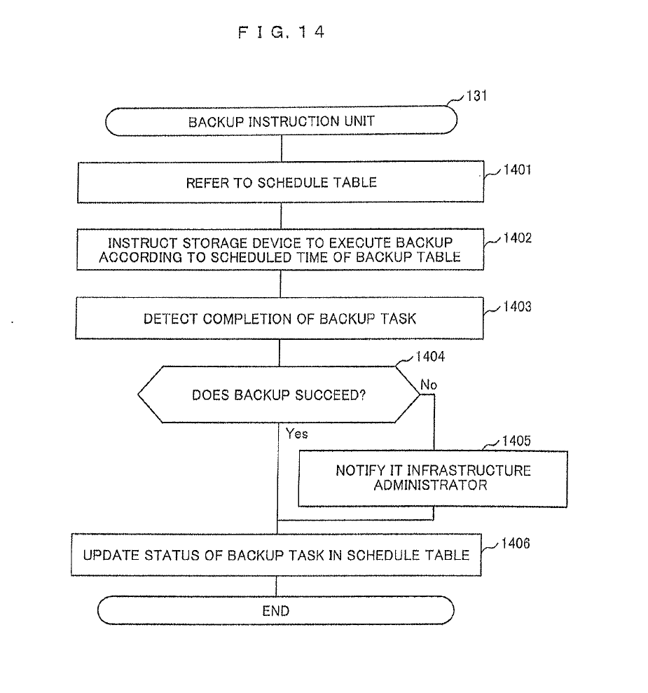

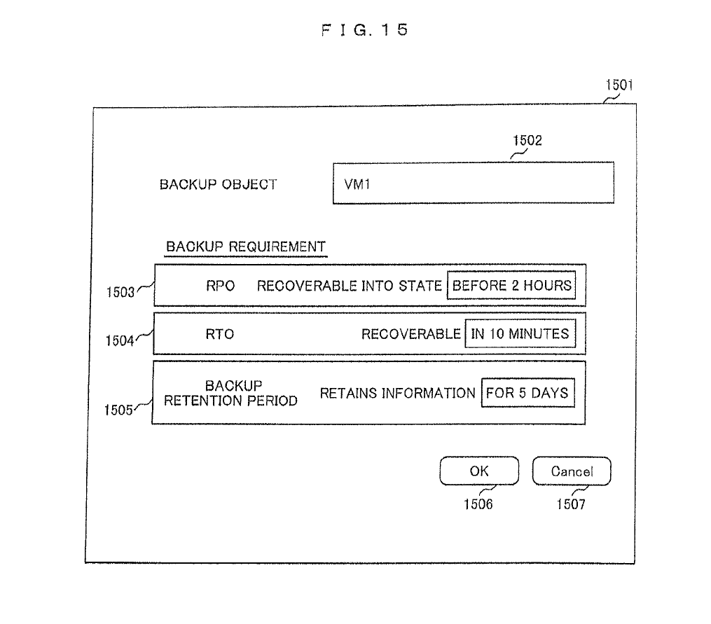

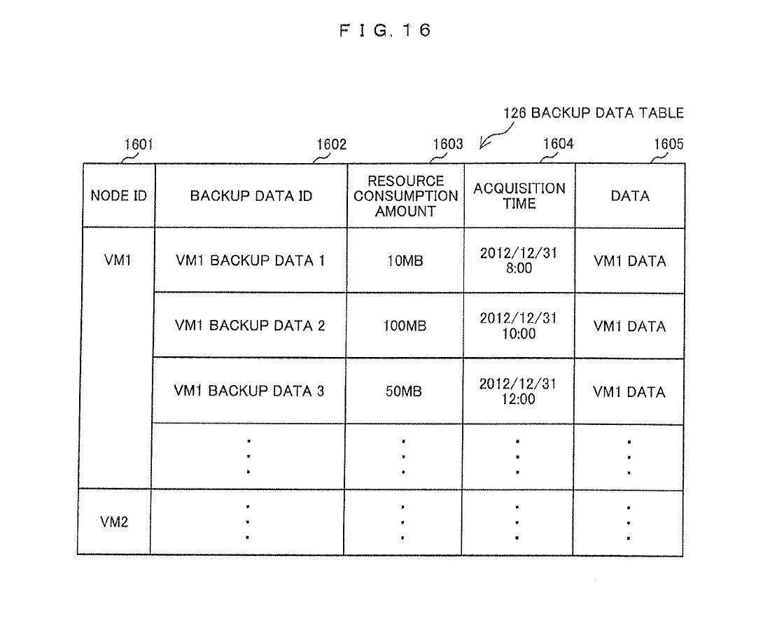

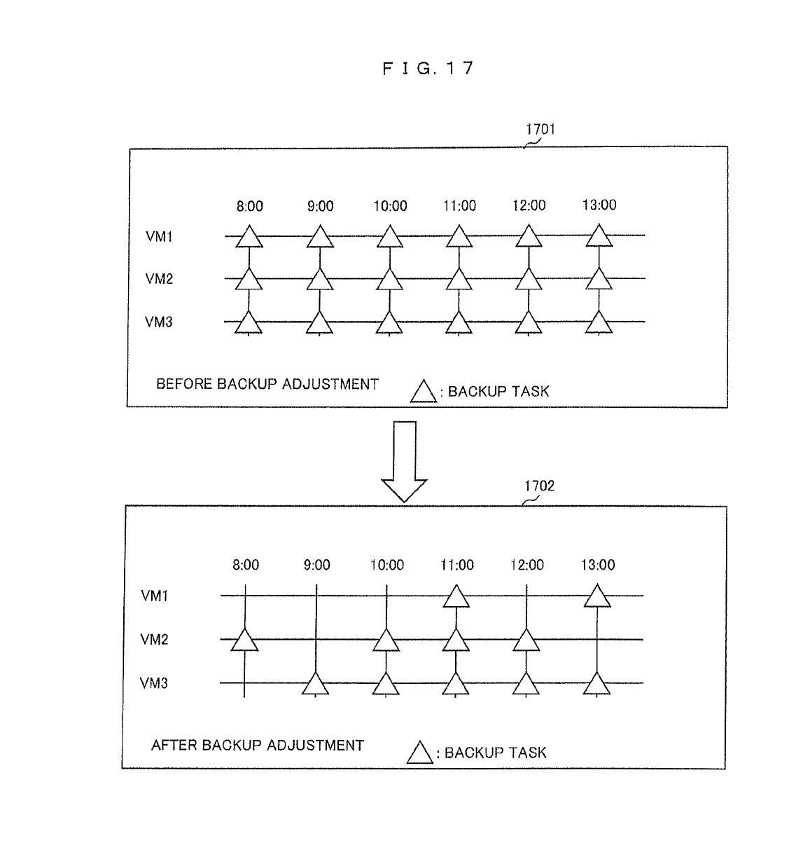

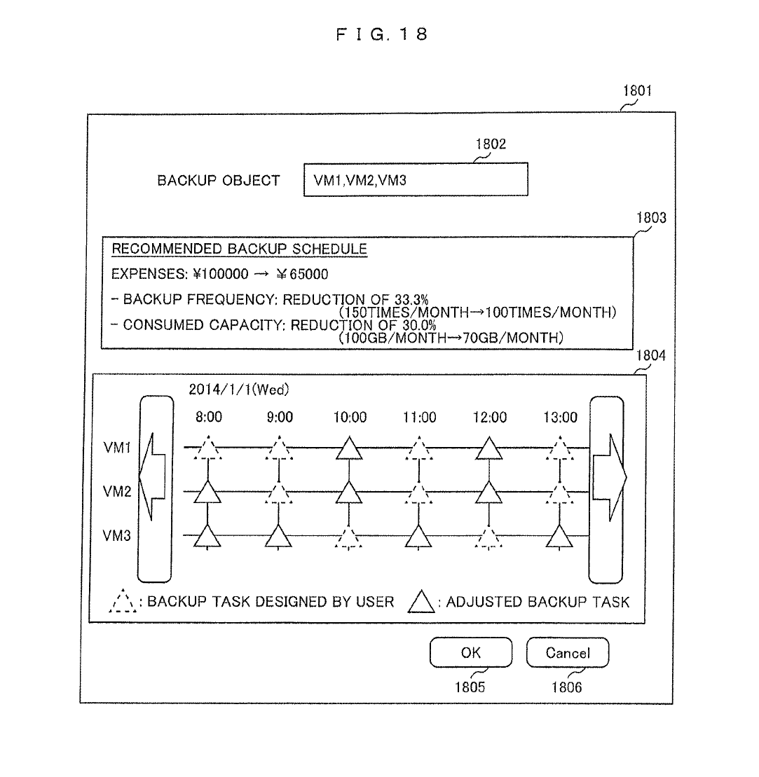

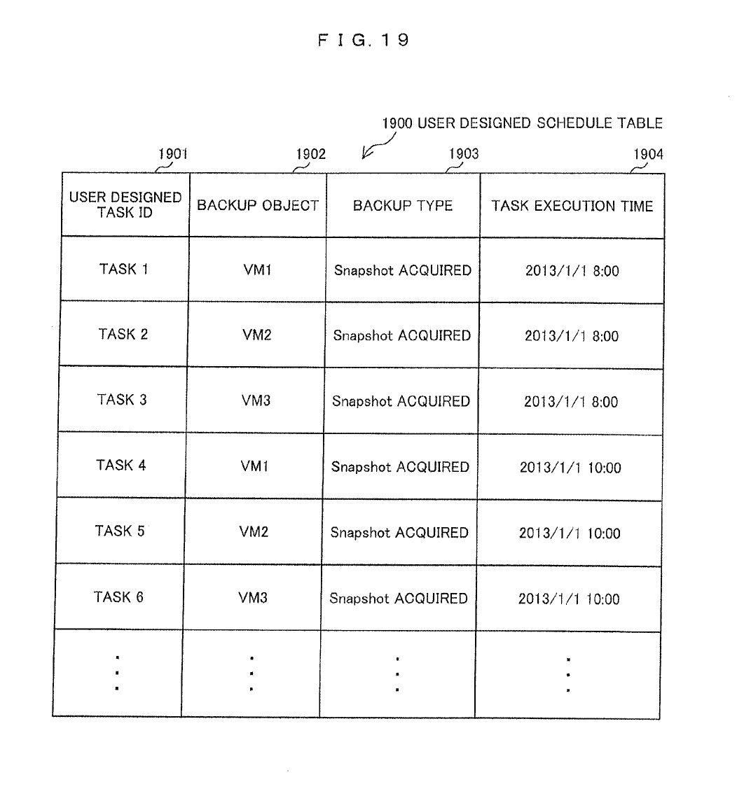

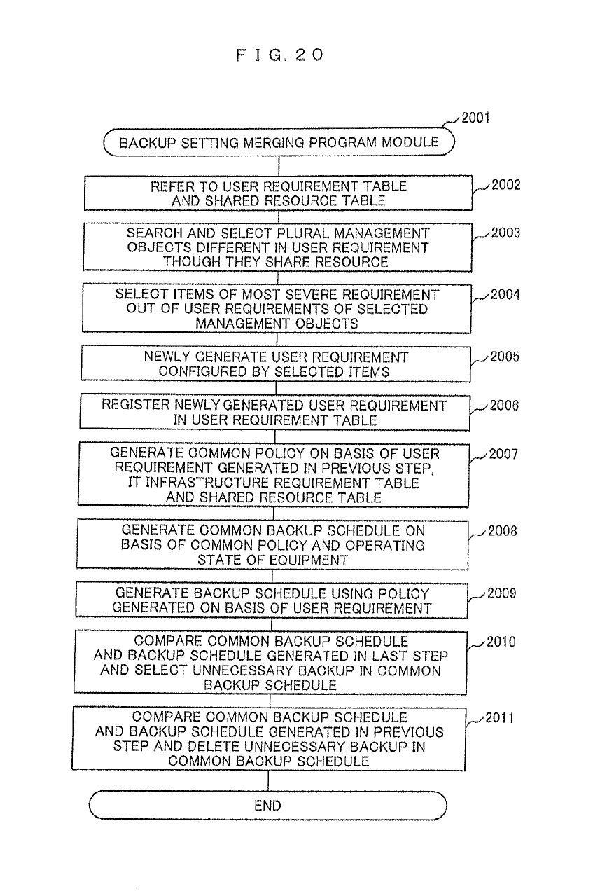

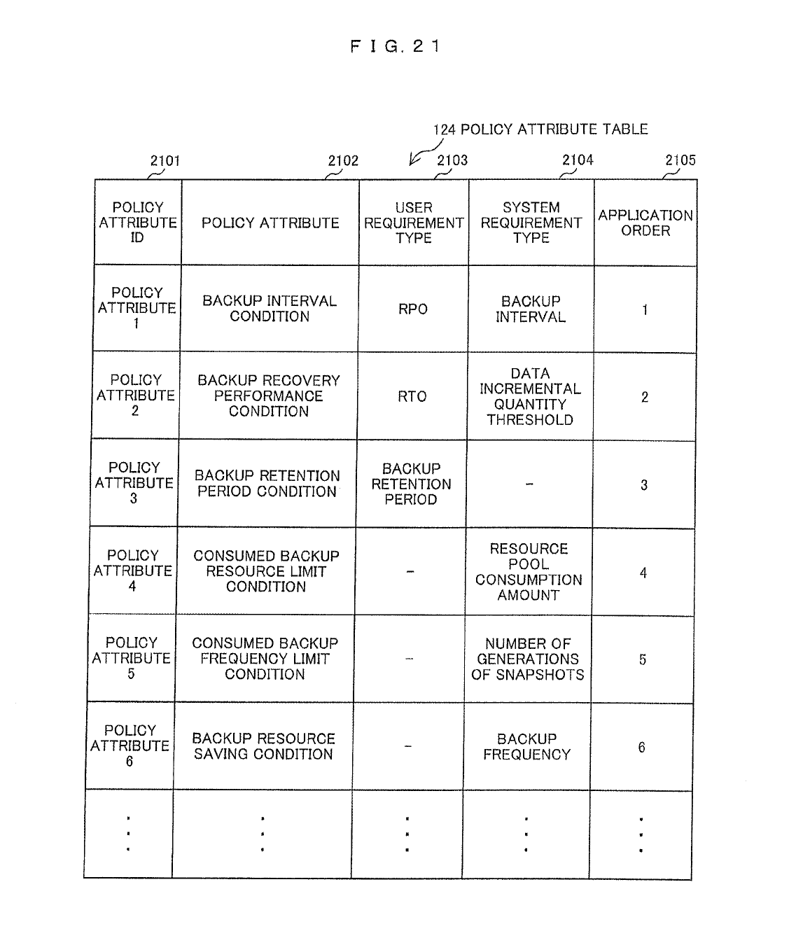

### BRIEF DESCRIPTION OF DRAWINGS

[FIG. 1] A block diagram showing a computer system in one embodiment of the present invention.

[FIG. 2] An outline of a process executed in the computer system in the one embodiment of the present invention.

[FIG. 3] An equipment information table stored in a management server in the one embodiment of the present invention.

[FIG. 4] A user requirement table stored in the management server in the one embodiment of the present invention.

[FIG. 5] An IT infrastructure requirement table stored in the management server in the one embodiment of the present invention.

[FIG. 6A] A policy table stored in the management server in the one embodiment of the present invention.

[FIG. 6B] A policy table stored in the management server in the one embodiment of the present invention.

[FIG. 7] A shared resource table stored in the management server in the one embodiment of the present invention.

[FIG. 8] A schedule table stored in the management server in the one embodiment of the present invention.

[FIG. 9] A backup information table stored in the management server in the one embodiment of the present invention.

[FIG. 10] A flowchart showing a process by a requirement acquisition program module stored in the management server in the one embodiment of the present invention.

[FIG. 11] A flowchart showing a process by a policy generation program module stored in the management server in the one embodiment of the present invention.

[FIG. 12A] A flowchart showing a process by a schedule adjustment program module stored in the management server in the one embodiment of the present invention.

[FIG. 12B] A flowchart showing the process by the schedule adjustment program module stored in the management server in the one embodiment of the present invention.

[FIG. 12C] A flowchart showing the process by the schedule adjustment program module stored in the management server in the one embodiment of the present invention.

[FIG. 13] A flowchart showing a process by an operating information monitoring program module stored in the management server in the one embodiment of the present invention.

[FIG. 14] A flowchart showing a process by a backup instruction unit in the management server in the one embodiment of the present invention.

[FIG. 15] A graphical user interface (GUI) in the one embodiment of the present invention.

[FIG. 16] A backup data table stored in the management server in the one embodiment of the present invention.

[FIG. 17] States before/after adjustment of a backup schedule in the one embodiment of the present invention.

[FIG. 18] The GUI for the management server to recommend a new backup schedule to a user in the one embodiment of the present invention.

[FIG. 19] A user designed schedule table stored in the management server in the one embodiment of the present invention.

[FIG. 20] A flowchart showing a process by a backup setting merging program module stored in a management server in one embodiment of the present invention.

[FIG. 21] A policy attribute table stored in the management server in the one embodiment of the present invention.

### DESCRIPTION OF EMBODIMENTS

One embodiment of the present invention will be described using the attached drawings below.

### First Embodiment

FIG. 1 is a block diagram showing one example of a computer system equivalent to a first embodiment of the present invention. The computer system is configured by a management server 101, a backup server 130, a server 160, a virtual server 167, and a storage device 150. In this description, the virtual server 167 is used for the same as a virtual machine (VM) and a virtual computer in the following description. In this case, some of plural virtual servers 167 share first IT resources and some of another virtual servers 167 share second IT resources different from the first IT resources. In this case, for the IT resources, a memory 163 and CPU 164 of the server 160, backup capacity and the number of Snapshot generations of the storage device 150 can be given.

The management server 101 is connected to a management interface 161 of the server 160 and a management interface 151 of the storage device 150 via a management network (NW for management) 140 in a management interface (management I/F) 104. Further, the management server 101 can be connected to the virtual server 167 via the server 160. Each management interface is an interface (or an I/O interface) for transmitting information of each piece of IT equipment (hereinafter merely called equipment) according to an inquiry and an operation instruction from the management server 101 and for executing control operation over each piece of equipment.

Further, a business network (business NW) 141 is a network used by a business application executed in the server 160 and the virtual server 167, is connected to WAN and others, and communicates with a client computer outside the computer system.

The management server 101 manages the operation of OS and an application respectively operated in the server 160 and controls power supply. The management server 101 is provided with a CPU (Central Processing Unit) 103 that computes, a memory 102 that stores a program executed in the CPU 103 and data accompanied by the execution of the program, the management interface 104 and an I/O device 105.

The CPU 103 is provided with one or more arithmetic units and executes a program stored in the memory 102. When the CPU 103 executes the program, functions with which the management server 101 is provided can be realized. A case where a program is described as a subject shows that the corresponding program is executed by the CPU 103.

The memory 102 stores programs executed by the CPU 103 and information required for the execution of the program. The programs and the information stored in the memory 102 will be described below.

The memory 102 stores the programs that realize a controller 110 and a management table group 120. A program and information not shown may also be stored in the memory 102.

The controller 110 is configured by plural program modules and executes processing for generating and adjusting a backup schedule.

Concretely, the controller 110 includes a policy generation program module 111, an operating state monitoring program module 112, a schedule adjustment program module 113 and a requirement acquisition program module 114.

The policy generation program module 111 generates a policy which is a concrete rule for adjusting a backup schedule where the execution of backup is scheduled, referring to a user condition stored in a user requirement table 121 input to the management server 101 by a user and system requirements defined by the system beforehand and stored in an IT infrastructure requirement table 127.

The operating state monitoring program module 112 acquires an operating state of the equipment and a usage state of resources managed by the management server 101. The operating state monitoring program module 112 may also acquire information by polling the equipment by itself and may also acquire information in a link with other management software that monitors the same equipment. Further, for example, an operating state of the virtual server 167 may also be acquired from virtualization based OS 175 that functions as a base of the virtual server 167.

The schedule adjustment program module 113 generates or changes a backup schedule so that it meets the abovementioned policy.

The requirement acquisition program module 114 acquires user requirements input by the user when backup of the virtual server is executed (information in the user requirement table 121).

The management table group 120 includes the user requirement table 121, an equipment information table 122, a shared resource table 123, a policy attribute table 124, a schedule table 125, an IT infrastructure requirement table 127, a policy table 128 and a backup information table 129.

The user requirement table 121 includes requirements (for example, a condition related to time used when the virtual server is restored on the basis of backup data) which are related to backup and which the user who is a tenant manager 200 wants to set in the virtual server 167 managed by itself.

In the equipment information table 122, information of the equipment which the management server 101 should manage is registered, and specifications of the equipment and information of resources shared among the equipment are stored.

The shared resource table 123 includes information of the equipment that shares IT resources shared between (among) plural pieces of the equipment, a usage state of the IT resources and others.

The schedule table 125 includes a backup schedule indicating a schedule of backup of the server to be managed. The schedule adjustment program module 113 registers a backup schedule stored in the schedule table. Further, a backup schedule stored in the schedule table may also be modified, adjusted, and reregistered.

The IT infrastructure requirement table 127 includes system requirement information (for example, a condition related to a used amount of IT resources) set by an IT infrastructure administrator. In this case, the management server authorizes the IT infrastructure administrator to access to a wider range than the user. For example, the management server authorizes the user to access to a virtual server which each user utilizes, however, the management server authorizes the IT infrastructure administrator to access to the virtual server which each user utilizes and IT resources utilized by these virtual servers so as to manage the virtual servers and the IT resources. Access authority may also be managed according to a conventional type method such as the management server discriminates access from the user and access from the IT infrastructure administrator by storing and managing ID (identification) and a password and limits the access from the user and the IT infrastructure administrator.

The policy table 128 includes a policy set to the server to be backed up. The policy generation program module 111 of the management server 101 correlates a user requirement type of the user requirement table 121 and system requirements of the IT infrastructure requirement table 127 on the basis of a user requirement type in a column 507 of the IT infrastructure requirement table 127, generates the policy, and stores it. The schedule adjustment program module 113 registers and updates (reregisters) a backup schedule stored in the schedule table 125 of the server to be backed up on the basis of the abovementioned condition.

The management interface 104 is an interface for connecting the management server 101 and the NW for management (management network) 140 as described above.

In FIG. 1, only one management interface is shown, however, plural management interfaces may also be provided. Further, one of the plural management interfaces is not connected to the management NW (the network for management) 140 but the one may also exist as an I/O interface between the management server and the storage device 150 in a case where the backup server 130 and the storage device 150 that stores data of the management server 101 exist.

The I/O device 105 includes an input unit such as a keyboard and a mouse and a display unit such as a display. An external record medium such as a USB memory may also be connected to the management server 101 via the I/O device 105. The tenant manager (user) may also access to the I/O device 105 and an IT infrastructure administrator may also access to it. A limiter that limits input from the I/O device or display on the I/O device according to the abovementioned access authority may also access to the I/O device.

The management server 101 itself may also be provided with no I/O device 105. For example, a method of connecting to an I/O device 105 via the management interface 104 and others and a method of connecting to a client terminal provided with an I/O device 105 can be given.

The storage device 150 provides a storage area used by the server 160 and the virtual server 167. The storage device 150 is provided with a disk controller 157 and a storage unit 156 such as a HDD (Hard Disk Drive) and an SSD (Solid State Drive).

In FIG. 1, only one disk controller 157 and only one storage unit are shown, however, plural disk controllers and plural storage units may also be provided.

The disk controller 157 controls the storage area and controls connection between the server 160 or the virtual server 167 and the storage area. The disk controller 157 is provided with a CPU (Central Processing Unit) 154 that computes, a memory 152 that stores a program executed in the CPU 154 and data accompanied by the execution of the program, the management interface 151, a disk interface 153 that connects the disk controller to the storage unit 156 and a port 155 that connects the disk controller to a storage NW (storage network). In FIG. 1, only one port is shown, however, plural ports may also be provided.

The storage unit 156 is provided with plural storage areas such as a resource pool 158 which is one of IT resources and stores each system data, each business data and each data for backup respectively of the server 160 and the virtual server 167. A backup data table 126 is included in the storage unit 156.

The server 160 is provided with the CPU 164, the memory 163, the management interface 161, an interface 162 for connecting to the business network 141, and an interface 165 for connecting to the storage network 143. In FIG. 1, only one representative interface 162 and only one representative interface 165 are shown, although respective plural interfaces may also be provided.

The CPU 164 is provided with one or more arithmetic units and executes a program stored in the memory 163. When the CPU 164 executes the program, functions with which the server 160 is provided can be realized. In the following description of a program as a subject, the corresponding program shall be executed by the CPU 164.

The memory 163 stores programs executed by the CPU 164 and information required for executing the corresponding program.

OS 166 from the memory is executed by the CPU 164 and under the OS 166, an application program that provides application and others are executed.

Further, the server 160 can provide the virtual server 167 in the memory though the details are omitted by utilizing a virtualization mechanism provided by the OS 166 for computer resources of the server 160 as shown in FIG. 1. The virtual server 167 is provided with IT resources such as virtual CPU 171, a virtual memory 170, and a virtual interface 172. The virtual CPU 171 utilizes resources of the physical CPU 164 supplied with the resources divided by the OS 166 of the server 160. When plural virtual servers 167 exist in the server 160, resources of the CPU 164 can be also supplied in a state in which the resources are divided into virtual CPU 167 of each virtual server 167. Resources of the physical memory 163 of the server 160 and resources of the interfaces 162, 165 can be also supplied to the virtual memory 170 and the virtual interface 172 with the resources divided like the virtual CPU 164. In FIG. 1, only one representative virtual server 167 is shown, although plural virtual servers may also be provided. Further, similarly, as for the virtual interface 172 of the virtual server 167, plural virtual interfaces may also be provided.

The virtual CPU 171 is provided with one or more arithmetic units like the CPU 164 of the server 160 and executes a program stored in the virtual memory 170. When the virtual CPU 171 executes the program, functions with which the virtual server 167 is provided can be realized.

The OS 175 is stored in the virtual memory 170 and controls a virtual device group in the virtual server 167. Further, an application program 173 is executed by the OS 175. The detection of a fault, power supply control by the OS, inventory management and others are provided by a manager 174 operated by the OS 175.

The backup server 130 includes a backup instruction unit 131 that instructs the server 160 and the virtual server 167 to execute backup. However, when the management server 101 includes the backup instruction unit 131, the management server 101 can also provide a function of the backup server.

FIG. 2 shows an outline of one example of a process in the present invention.

The management server 101 accepts the input of a condition of a time limit related to a recovery process of the system such as RPO (Recovery Point Objective), RTO (Recovery Time Objective) and a retention period of backup from a user such as the tenant manager 200 that manages the virtual server (VM in FIG. 2) 167 via the I/O device 105. In this case, RPO is an index (time) showing the system can be recovered into a state before how many hours when disaster occurs. Further, RTO denotes time required for recovery.

The tenant manager 200 is a user who manages one or plural virtual servers 167 (for example, VM1 to VM3) and inputs a condition of a time limit related to the recovery process of the system from an input terminal or the I/O device 105 connected to the management server 101 and others. For example, the tenant manager inputs RPO, RTO, a retention period of backup data and others. The IT infrastructure administrator is authorized to administrate not only one or plural virtual servers 167 managed by the tenant manager 200 but the storage device 150 including the backup resources 158 of the virtual server 167, the physical server 160 that provides computer resources to the virtual server 167 and others. The IT infrastructure administrator provides one or plural virtual servers 167 and the backup resources 158 to plural tenant managers.

The management server 101 registers temporal requirements related to the recovery process of the system and input from the user in the user requirement table 121.

Next, the policy generation program module 111 generates a policy of a schedule for determining a backup schedule of one or plural virtual servers 167 on the basis of information from the user requirement table 121, the IT infrastructure requirement table 127 and the equipment information table 122, and registers the policy in the policy table 128. In this case, information in the user requirement table 121 input by the user who manages the virtual server 167 and information in the IT infrastructure requirement table 127 administrated by the IT infrastructure administrator who administrates an IT infrastructure are different in the manager/administrator or a person who inputs; however, to execute backup, a backup schedule that meets these two requirements (conditions) is required to be made out. Therefore, the management server generates a policy on the basis of these pieces of information. A backup schedule can be generated and modified without making the user input an IT infrastructure condition or conscious of an IT infrastructure condition by providing the management server a mechanism for generating a policy. Further, the IT infrastructure administrator can generate and modify a backup schedule without making the IT infrastructure administrator conscious of a change by the user of user requirements for the VM. Moreover, the management server stores a type of a user requirement corresponding to an IT infrastructure requirement so as to correlate the user requirement and the IT infrastructure requirement.

The operating state monitoring program module 112 monitors a situation of backup resources in the virtual server 167 and the storage device 150 in synchronization or asynchronization with the process of the policy generation program module 111, and updates information in the equipment information table 122 and the shared resource table 123. The shared resource table 123 includes state information and operational information of resources generated by dividing physical resources of the storage device 150 and others and shared by plural physical servers and virtual servers.

The schedule adjustment program module 113 generates a backup schedule of one or plural virtual servers 167 on the basis of information in the policy table 126 and the shared resource table 123 and registers it in the schedule table 125.

Further, when a backup schedule is already registered in the schedule table 125, a new schedule in which backup is added, backup is deleted or the execution time of backup is changed is registered in the schedule table 125 on the basis of the registered backup schedule, and the existing extra schedule is deleted. The management server 101 can eliminate the consumption of useless backup resources, meeting requirements described in the policy table 126 without requiring help of the user 200 and others by applying the policy to the existing backup schedule.

Moreover, plural VMs that share resources are treated as one group and execution time of a task may also be changed. As in FIG. 2, the VM1 to the VM3 share the backup resources 158, the execution time of a task is changed with the VM1 to the VM3 as one group. Hereby, a backup schedule of another VM in the same group can be registered and deleted also in consideration of effect of a consumed state (for example, consumption time) of shared resources caused by changing a backup schedule of one VM out of the plural VMs.

FIG. 3 shows the equipment information table 122 stored in the management server 101. The equipment information table 122 includes configuration information of equipment managed by the management server 101, information of software operated in the equipment to be managed, specification information of the equipment to be managed and authentication information required when operational information of the equipment to be managed and others are acquired. In this embodiment, different types of equipment such as various servers including the server 160 and the virtual server 167 and the storage device 150 such as the storage device 150 is registered in the same table, however, a table may also be provided every type.

In FIG. 3, node ID of equipment managed by the management server 101 such as the server 160 is stored in a column 301 and each piece of equipment is uniquely identified by this identifier. The input of data stored in the column 301 can be omitted by designating any of each column used in this table 122 or combined plural columns. Further, the node ID may also be automatically allocated in ascending order and others by the management server 101.

A column 302 stores a management IP address allocated to equipment to be managed such as the server 160. The management server 101 is connected to the equipment to be managed such as the server 160 on the basis of the management IP address.

A column 303 stores a user name and a password used when the management server 101 is connected to the equipment to be managed such as the server 160. The user name is described in front of a separator ‘:’ in the drawing and the password is described at the back of the separator.

A column 304 stores information of OS of the equipment to be managed such as the server 160.

A column 305 stores a model name of the equipment to be managed such as the server 160. The model name is information related to the infrastructure and is information that tells a manufacturer and the performance of the equipment to be managed such as the server 160 and a limit of a configurable system. Further, the model name is information that enables discriminating whether the configuration of the equipment to be managed is the same or not.

A column 306 stores the configuration of the equipment to be managed such as the server 160.

A column 307 stores backup information 901 in the corresponding backup information table 129.

FIG. 4 shows the user requirement table 121 stored in the management server 101.

The user requirement table is a table for storing requirements input from the user granted first access authority and including RPO, RTO and a retention period of backup respectively related to a process based upon backup for recovering a virtual computer (recovery process). Regarding requirements from the user, a value input from a terminal connected to the I/O device 105 of the management server 101 is read by the management server 101 and its information may also be stored in the user requirement table 121, the user prepares a setting file in which requirements related to backup are written beforehand, the setting file is read by the management server 101, and information in the setting file may also be stored in the user requirement table 121.

A column 401 stores user ID with which the management server 101 uniquely identifies the user who inputs requirements. The input of data stored in the column 401 can be omitted by designating any of each column used in this table 121 or combined plural columns. Further, the user ID may also be allocated automatically in ascending order and others by the management server 101.

A column 402 stores user requirement ID with which the management server 101 uniquely identifies a user requirement. The input of data stored in the column 402 can be omitted by designating any of each column used in this table 121 or combined plural columns. Further, the user requirement ID may also be automatically allocated in ascending order and others by the management server 101.

A column 403 stores ID for identifying the system and the equipment to be backed up. For the ID, the node ID stored in the column 301 of the equipment information table 122 and others are stored.

A column 404 stores ID for uniquely identifying a sub-requirement when the user requirement includes the further fine user requirement (the sub-requirement). The input of data stored in the column 404 can be omitted by designating any of each column used in this table 121 or combined plural columns if only relation between the sub-requirement and the user requirement to which the sub-requirement is subordinate is clear. Further, the sub-requirement ID may also be automatically allocated in ascending order and others by the management server 101.

A requirement type of user requirements is stored in a column 405. The requirement type is information such as RPO, RTO and a retention period of backup in this embodiment. In this embodiment, a time limit requirement (condition) such as RPO, RTO and a retention period of backup in the process for recovering a virtual computer using backup is given as a representative example; however, a requirement (a condition) related to the process for recovering a virtual computer using another backup such as Recovery Level Objective (RLO) may also be added. The RLO is an index indicating a recovery level of a business system in recovering from disaster. For example, the RLO is an evaluation index indicating a degree of recovery as in cases where the RLO guarantees recovery of the OS when the RTO is set to one minute and the RLO guarantees recovery of the business system when the RTO is set to one hour.

In a column 406, contents of each user requirement are stored. For example, as for requirements of RPO, such information as the business system can be recovered into a state before two hours of the occurrence of disaster is stored.

FIG. 5 shows the IT infrastructure requirement table 126 stored in the management server 101.

The IT infrastructure requirement table 126 includes system requirements input by the IT infrastructure administrator who is granted second access authority.

In this case, the second access authority granted the IT infrastructure administrator has a wider range than the first access authority granted the user. Concretely, the IT infrastructure administrator having the second access authority accesses and manages not only one or plural virtual servers 167 which the tenant user 200 having the first access authority accesses and manages but the storage device 150 including the backup resources 158 of the virtual server 167 and the physical server 160 that provides computer resources to the virtual server 167. The IT infrastructure administrator provides one or plural virtual servers 167 and the backup resources 158 to plural tenant managers 200. Therefore, the management server 101 registers information input by the IT infrastructure administrator in the IT infrastructure requirement table 126 in view of performance and an operating state of the IT infrastructure as a system requirement. Or the management server 101 generates a system requirement on the basis of past stored information and it may also be registered as a system requirement.

For example, if a resource to be managed to which the following requirement is applied has performance that recovers differential backup data for 1 GB in one minute when RTO that the business system can be recovered in five minutes is set as a user requirement, the RTO cannot be met unless backup is acquired when differential backup data reaches 5 GB. However, in consideration of time required for backup itself and possibility that data increases during processing and exeeds 5 GB when the processing is started since the differential reaches 5 GB, backup should be started before the differential backup data reaches 5 GB. Therefore, for a threshold (a data incremental quantity threshold in a column 505 in the IT infrastructure requirement table 127) at which backup is started, information that warning should be given when the differential exceeds 80% of 5 GB is input as a system requirement.

A column 501 stores ID for the management server 101 to uniquely identify the system requirement. The input of data stored in the column 501 can be omitted by designating any of each column used in this table 127 or combined plural columns. Further, the system requirement ID may also be automatically allocated in ascending order and others by the management server 101.

A column 502 stores ID for identifying the system and the equipment to be backed up. For the ID, the node ID in the column 301 of the equipment information table 122 and others are stored.

In a column 503, ID for uniquely identifying a sub-requirement when the system requirement includes the further fine system requirement (the sub-requirement) is stored. If only relation between the sub-requirement and the user requirement to which the sub-requirement is subordinate is clear, the input of the data stored in the column 502 can be omitted by designating any of each column used in this table 127 or combined plural columns. Further, the sub-requirement ID may also be automatically allocated in ascending order and others by the management server 101.

In a column 504, a requirement type of the system requirement is stored. For the requirement, a resource consumption amount limit which is a requirement (a condition) for limiting a consumption amount of IT resources and a performance requirement which is a requirement (a condition) for meeting performance requested by the user can be given. The former is a requirement for preventing a fault from occurring because finite backup resources run out and for example, a usage rate or a consumption amount of the resource pool, the number of generations of Snapshots, a frequency of backup and a backup interval showing an interval between each backup can be given. Further, for the latter, the data incremental quantity threshold which is a threshold for meeting RTO specified by the user can be given. The data incremental quantity threshold in this case is information for limiting differential backup data volume stored in the storage device 150. More concretely, the data incremental quantity threshold is set so as to limit the differential backup data volume stored in the storage device 150 so that a limit in restoring (restoring process) based upon RTO is met. The data incremental quantity threshold is discriminated from the resource consumption amount limit as a performance requirement in this embodiment; however, the data incremental quantity threshold may also be included in the resource consumption amount limit.

In a column 505, a system requirement item is stored. For example, the system requirement item corresponds to the resource consumption amount limit such as the usage rate of the backup resource pool, the number of generations of Snapshots, the frequency of backup and the backup interval respectively described above and corresponds to the performance requirement such as the data incremental quantity threshold.

A column 506 stores detailed contents of the requirement. For example, in a case of the resource pool usage rate, it can be defined as the system requirement that the IT infrastructure administrator is alerted when the usage rate of the resource pool exceeds 80% so as to prevent backup from being impossible because the daily storage of backup data exceeds the capacity of the resource pool. In place of alerting the IT infrastructure administrator, the usage rate of the resource pool may also be kept below 80% by instructing the management server 101 to detect warning, to expand the resource pool or to delete extra backup data. Further, 80% of the resource usage rate is one example and the IT infrastructure administrator may also freely change it.

In a case of the number of generations of Snapshots, generations of Snapshots are consumed for daily backup, although, as the number of generations of Snapshots is finite, it can be defined as the system requirement that the IT infrastructure administrator is alerted when the consumption of the number of generations of Snapshots exceeds 800 if the maximum number of generations of Snapshots is 1000. In place of alerting the IT infrastructure administrator, the number of used generations of Snapshots may also be kept below 80% by instructing the management server 101 to detect warning and to delete the extra generations of the Snapshots. Further, 80% in the usage rate of the number of generations of Snapshots is one example and the IT infrastructure administrator may also freely change it. In a case of the frequency of backup, resources consumed by backup can be reduced by inhibiting the execution of backup while an object of management is halted.

Moreover, in the column 506 of the IT infrastructure requirement table 127, it is described that the equipment to be managed is halted; however, it is detected that OS and s business system of the equipment to be managed are halted and backup may also be inhibited when the OS and the business system are halted.

In addition, one more requirement for inhibiting the frequency of backup is a requirement to be tackled when the currently set backup interval is set to an extremely short one than the minimum backup interval to restore to a recovered state requested as the RPO and excessive backup is executed. In one example described in the IT infrastructure requirement table 127, when the currently set backup interval is below 80% of the minimum backup interval led from the RPO, adjustment is made so that the backup interval is 80% or more of the minimum backup interval led from the RPO. For example, in a case where RPO is set to a requirement that the business system can be recovered into a state before two hours when disaster occurs, the minimum required backup interval as a backup interval led from the RPO is 120 minutes (two hours); however, when a backup interval is set to 60 minutes, backup is executed twice and it results in extra backup. In this embodiment, as one example, the backup interval is changed to 80% or more, although the backup interval is not necessarily required to be 80%, and the IT infrastructure administrator can freely set a backup interval.

In a case of the data incremental quantity threshold, it is defined in RTO that the business system can be recovered in five minutes and a final data incremental quantity threshold can be determined as 400 MB acquired by calculating “5 (min)×100 (MB/min)×80%” on the basis of information (described in a column 705 in FIG. 7 described later) that 125 MB can be restored per minute in the resource pool.

The column 507 stores information of a requirement type of a user requirement related to a system requirement. The requirement type is used in generating a policy. The generation of a policy will be described referring to FIG. 11 described later.

FIGS. 6A and 6B show the policy table 128 stored in the management server 101.

The policy table 128 includes policies generated on the basis of a user requirement stored in the user requirement table 121 based upon the first access authority and a system requirement stored in the IT infrastructure requirement 126 based upon the second access authority. The policy is information generated by instructing the management server 101 to correlate the user requirement for backup and the system requirement indicating a property of the system that executes backup on the basis of the type (the requirement type 405 and the user requirement type 507) of the user requirement. The schedule adjustment program module 113 adjusts a schedule of backup on the basis of these policies.

A column 601 stores ID for the management server 101 to uniquely identify the policy. The input of data stored in the column 601 can be omitted by designating any of each column used in this table 128 or combined plural columns. Further, the policy ID may also be automatically allocated in ascending order and others by the management server 101.

A column 602 stores ID for identifying the system and the equipment respectively to be backed up. For the ID, the node ID and others in the column 301 in the equipment information table 122 are stored.

In a column 603, contents of each policy are stored. For example, a policy 1 is generated in a procedure of limiting a time difference (a backup interval) from the last time of backup till the next time of backup between 96 minutes and 120 minutes by calculating the maximum backup interval 120 minutes and the minimum backup interval 96 minutes (a result of calculating 120 min×80%) on the basis of the user requirement described in 1-1 of the user requirement 1 of the user 1 in the user requirement table 121 and related to RPO that the business system can be recovered into a state before two hours when disaster occurs and the system requirement described in 1-4 of the resource pool 1 in the system requirement 1 in the IT infrastructure requirement table 127 and related to the resource consumed amount limit that backup execution time should be changed so that a backup interval is 80% or more when the backup interval is below 80% of time led from RPO.

A policy 2 is a policy for calculating backup data incremental quantity 500 MB (a result of calculating 125 MB×5 min×80%) that meets both the user requirement and the system requirement and can be restored on the basis of the user requirement described in 1-2 of the user requirement 1 of the user 1 in the user requirement table 121 and related to RTO that the business system can be recovered in five minutes, the system requirement described in 1-5 of the resource pool 1 of the system requirement 1 in the IT infrastructure requirement table 127 and related to a performance requirement that warning should be output when data incremental quantity that meets RTO and can be restored exceeds 80% and performance information in the column 705 of the shared resource table 123 that 125 MB can be restored per hour, and comparing the abovementioned backup data incremental quantity and a backup data cumulative amount at the time of the next backup calculated on the basis of a previous cumulative amount of backup data stored in a column 907 in the backup information table 129 and mean consumed backup data capacity per hour in the backup information table 129.

A policy 3 is a policy generated on the basis of 1-3 of the user requirement 1 in the user requirement table 121 and backup data acquired by the management server 101 is stored according to the user requirement so as to prevent the backup data from being deleted.

A policy 4 is a policy generated on the basis of the requirement described in 1-3 of the resource pool 1 of the system requirement 1 in the IT infrastructure requirement table 127 that backup should be inhibited while the equipment to be managed is halted and while the equipment to be managed is halted, backup tasks are reduced so as to reduce a frequency of backup.

A policy 5 is a policy generated on the basis of 2-1 of the user requirement 2 of the user 1 in the user requirement table 121 and 1-4 of the resource pool 1 of the system requirement 1 in the IT infrastructure requirement table 127. A method of generating the policy is similar to that of the policy 1.

A policy 6 is a policy generated on the basis of 2-2 of the user requirement 2 of the user 1 in the user requirement table 121 and 1-5 of the resource pool 1 in the IT infrastructure requirement table 127. A method of generating the policy is similar to that of the policy 2.

A policy 7 is a policy generated on the basis of 2-2 of the user requirement 2 of the user 1 in the user requirement table 121 and 1-5 of the resource pool 1 in the IT infrastructure requirement table 127. A method of generating the policy is similar to that of the policy 3.

A policy 8 is a policy generated on the basis of the requirement described in 1-1 of the resource pool 1 of the system requirement 1 in the IT infrastructure requirement table 127 that warning should be output when a usage rate of the resource pool is below 80%, and the usage rate of the resource pool at the time of the next backup is calculated on the basis of information of backup tasks scheduled to be executed till the next backup in the schedule table 125 and backup data capacity consumed till the next backup calculated from the mean consumed backup data capacity per hour in the backup information table 129. It is judged whether or not the acquired usage rate of the resource pool at the time of the next backup exceeds 80%.

A policy 9 is a policy generated on the basis of the requirement described in 1-2 of the resource pool 1 of the system requirement 1 in the IT infrastructure requirement table 127 that warning should be output when the number of generations of Snapshots reaches 80% of the maximum number of generations of Snapshots. It is judged whether the number of generations of Snapshots at the time of the next backup exceeds 80% or not.

A column 604 stores user requirement ID and sub-requirement ID respectively based upon which the corresponding policy is generated. In FIGS. 6, a part encircled by parentheses denotes a sub-requirement.

A column 605 stores system requirement ID and sub-requirement ID respectively based upon which the corresponding policy is generated. In FIGS. 6, the part encircled by the parentheses denotes the sub-requirement.

In a column 606, policy attribute ID to which the corresponding policy belongs is stored. When the policy is classified according to an attribute of the policy registered in the policy attribute table 124, the classified policy attribute is stored.

For example, as the policy 1 is a policy related to a backup interval, it is classified into a backup interval condition of a policy attribute 1 in the policy attribute table 2101. Therefore, in the column 606, the policy attribute 1 is stored.

FIG. 21 shows the policy attribute table 124 stored in the management server 101. The policy attribute table 124 is a table for classifying the policies in the policy table 128 and the IT infrastructure administrator determines policies on the basis of the combination of a user requirement type 2103 and a system requirement type 2104 beforehand and inputs them. Further, the policy attribute table 124 is provided with information of the order of the applied policy when the schedule adjustment program module 113 adjusts a schedule using the policy.

A column 2101 stores ID for the management server 101 to uniquely identify the attribute of the policy. The input of data stored in the column 2101 can be omitted by designating any of each column used in this table 124 or combined plural columns. Further, the policy attribute ID may also be automatically allocated in ascending order and others by the management server 101.

A column 2102 stores attributes of the policies. The attributes of the policies denote information generated by the policy generation program module 111 for classifying the policies stored in the policy table 128.

The IT infrastructure administrator defines the attributes of the policies by combining the user requirement type 2103 and the system requirement type 2014. For example, as the combination of RPO in the user requirement type 2103 and the system requirement type 2104 is the requirement related to a backup interval, a policy attribute as a backup interval condition is created.

In the column 2103, the user requirement type used when the policy attribute is defined is stored. The user requirement type is written to the column 405 in the user requirement table 121.

In the column 2014, the system requirement type used when the policy attribute is defined is stored. The system requirement type is written to the requirement item in the column 505 in the IT infrastructure requirement table 127.

A column 2105 stores information showing order in which the policies are applied. When the schedule adjustment program module 113 executes processing according to the policy, what policy is applied in advance is determined according to sequential relation of the policy attribute to which the policy corresponds. It is this column that has information of sequential relation among the attributes of the policies. Although the IT infrastructure administrator sets the sequential relation of the application beforehand, basically, a backup interval which can be judged on the basis of RPO and others of the user requirement and a performance condition required for system recovery are preceded and next, IT infrastructure administrator, a condition based upon specifications (capacity of resources and the number of generations of Snapshots) of backup resources of the IT infrastructure is preceded. Finally, a condition for saving backup resources is set.

FIG. 7 shows the shared resource table 123 stored in the management server 101.

The shared resource table 123 is a table including information of the equipment to be managed such as the server 160 and the virtual server 167 respectively to be backed up that shares computer resources and resources of the storage device 150, performance and others which the resources have. In this embodiment, although only the resource pool in the storage device 150 is described, however, for a shared resource, components of the storage device 150 such as a port of the storage device 150 and an MPB (microprocessor blade) and resources of the server 160 upon which the virtual server 167 is based may also be handled.

A column 701 stores ID for the management server 101 to uniquely identify a shared resource. The input of data stored in the column 701 can be omitted by designating any of each column used in this table 123 or combined plural columns. Further, the shared resource ID may also be automatically allocated in ascending order and others by the management server 101.

A column 702 stores information of a resource shared by the server 160 and the virtual server 167 respectively to be backed up.

A column 703 stores information for identifying the virtual server 167 and others that share the shared resource in the column 702.

In a column 704, information for identifying an item related to specifications (capacity of the shared resource in the column 702, the number of generations of Snapshots and restore performance) of the shared resource in the column 702 is stored.

In columns 705 to 708, restore performance of the resource which the system/equipment in the column 703 shares, the maximum resources, the current resource consumption amount and a supposed resource consumption amount are stored.

The column 705 stores information related to performance of the shared resource in the column 702. Concretely, when backup data is stored in the resource pool 1, performance information in restoring data is stored in the column 705.

In a column 706, information related to the capacity of the shared resource in the column 702 and the maximum number of generations of backup is stored.

In a column 707, information of the current consumption amount related to the capacity of the shared resource in the column 702 and the number of generations of backup is stored.

In a column 708, information related to the capacity of the shared resource in the column 702 and the number of generations of backup and used by the schedule adjustment program module 113 during the adjustment of a backup schedule is stored. Every time the schedule adjustment program module 113 adjusts one backup task, a consumption amount of the resource supposed when the backup task is executed is added to a supposed resource consumption amount in the column 708 and the supposed resource consumption amount is utilized when it is judged whether the execution of the following backup task is possible or not.

FIG. 8 shows the schedule table 125 stored in the management server 101.

The schedule table 125 includes time at which the management server 101 is to execute or executed backup of the server 160 and the virtual server 167 respectively to be managed.

In FIG. 8, one backup is registered as one backup task. In a field of each backup task, information for identifying an object of backup, a type of backup, precedence utilized when a backup schedule is made, execution time of the backup task, a result of the execution of the backup task and a flag showing whether the adjustment of the backup schedule is already made or not are stored. Further, a task when the tenant manager 200 manually executes or executed backup in place of backup scheduled beforehand may also be registered. (The manual backup means backup executed according to an instruction from the tenant manager without the generation of the policy shown in FIG. 6A or 6B by the management server 101.) In that case, the management server 101 may also update a backup schedule automatically after the manual backup on the basis of a history of the manual backup. The tenant manager and the IT infrastructure administrator may also set the backup task which is registered in the schedule table 125 and which is an object of one backup schedule adjustment for a fixed period such as for one month and for one year or until the resource for backup exceeds a fixed threshold or till expiry of a backup retention period of the certain target system/equipment or for a period in which full backup of the certain target system/equipment is performed.

A column 801 stores ID for the management server 101 to uniquely identify the backup task. The input of data stored in the column 801 can be omitted by designating any of each column used in this table 125 or combined plural columns. Further, the task ID may also be automatically allocated in ascending order and others by the management server 101.

A column 802 stores ID for identifying the equipment to be backed up. For the ID, the node ID and others in the equipment information table 122 are stored.

A column 803 shows a type of backup in executing the backup. In this column of FIG. 8, backup depending upon Snapshots and full backup are written, although another backup method may also be taken. Basically, backup depending upon Snapshots is frequently executed and full backup is rarely executed. In backup depending upon Snapshots, differential data since the last Snapshot backup and the last full backup is backed up. In a case of full backup, cumulative differential data in Snapshot backup are merged. Therefore, immediately after full backup, no differential data exists.

A column 804 stores precedence of the backup task. In this embodiment, full backup is set to higher precedence and Snapshot backup except it is set to lower precedence. In the case of full backup, since backup is executed in a state in which all differential information updated by plural Snapshots is applied, full backup has merits in that system recovery is sped up and in that the number of generations of Snapshots can be increased by deleting Snapshots made unnecessary in full backup. Therefore, full backup is set to higher precedence. In the meantime, the management server 101 may also set Snapshot backup to higher precedence and may also set full backup to lower precedence. In this case, the management server 101 can reduce time required for backup.

In a column 805, time at which the backup task is scheduled to be executed or time when the backup task is executed is stored.

A column 806 stores a result of the execution of the backup task. When backup succeeds, information of success is stored and when backup fails, information of failure is stored. Further, for the backup task in which time to execute the backup task does not come yet and no backup is executed, information of “unexecuted” is stored.

FIG. 9 shows the backup information table 129 stored in the management server 101.

The backup information table 129 is a table that stores setting related to backup when backup setting is made in the equipment managed by the management server 101. In this embodiment, respective backup setting of VM1, VM2, VM3 of the virtual server 167 is written.

In a column 901, ID for the management server 101 to uniquely identify the backup task is stored. The input of data stored in the column 901 can be omitted by designating any of each column used in this table 125 or combined plural columns. Further, the backup information ID may also be automatically allocated in ascending order and others by the management server 101.

In a column 902, ID showing the equipment to be backed up such as the virtual server 167 is stored. For the ID stored in the column 902, the node ID in the column 301 in the equipment information table 122 is written. What node ID is stored depends upon correspondence relation with the backup ID set for the backup setting in the column 307 in the equipment information table 122.

In a column 903, policy ID applied to the equipment to be backed up and stored in the column 902 is stored. The policy ID stored in the column 903 is determined by correspondence relation between the column 601 including the policy ID and the column 602 including the target system/equipment to which the policy is applied respectively in the policy table 128 shown in FIGS. 6.

A column 904 stores the mean consumed backup data capacity which is mean consumed resource capacity consumed per backup. The IT infrastructure administrator determines the calculation of the mean consumed resource capacity. Further, the management server 101 records variation of an increasing amount of backup and may also calculate the mean consumed resource capacity on the basis of the recorded data. For example, the mean consumed resource capacity may also be mean consumed resource capacity of backup executed in one week and may also be mean consumed resource capacity of backup executed in one month. Moreover, if a trend of a backup increasing amount is greatly different depending upon a difference in a time zone and difference between a weekday and a holiday, a mean resource consumption amount may also be registered every time zone and may also be registered with a weekday and a holiday discriminated.

A column 905 shows a cumulative amount of the current backup data of the backup object equipment shown in the column 902. As it is differential backup data volume, a cumulative amount is 0 MB when full backup is executed.

A column 906 shows a supposed backup data cumulative amount of the backup object equipment shown in the column 902 when backup is continued. This value is a value temporarily utilized in a process in which the schedule adjustment program module 113 adjusts a schedule.

A column 907 stores the current operating state of the backup object equipment shown in the column 902.

A column 908 stores an operating schedule of the backup object equipment shown in the column 902. The operating schedule may also be manually set by the user, the management server 101 accumulates information of an operating state of the backup object equipment, the operating schedule may also be statistically calculated on the basis of the accumulated information, and when the backup object equipment is the virtual server 167 and others, information may also be acquired from virtual base OS and another linked backup software.

A column 909 stores information of whether backup is acquired when the backup object equipment is not operated or not. In FIG. 9, “acquired” shows that backup is acquired when the backup object equipment is not operated and “none” shows that backup is not acquired when the backup object equipment is not operated.

FIG. 10 is a flowchart showing one example of a process executed by the requirement acquisition program module 114 in the management server 101. This process is a process in which the management server 101 acquires a request related to backup input by the user and stores it in the user requirement table 121.

In a step 1001, a requirement related to backup is acquired from the user. At this time, the requirement from the user may also be acquired by reading a value input from a terminal (not shown) connected to the I/O device 105 of the management server 101 by the management server 101, the user prepares a setting file to which the user writes a requirement related to backup beforehand, and the requirement may also be acquired by reading the setting file by the management server 101. Concretely, the management server 101 acquires the respective information of the target system/equipment 402, the sub-requirement ID 403, the requirement type 404 and the contents of the user requirement 405 in relation to the user requirement ID 401.

In a step 1002, the requirement acquired in the step 1001 is registered in the user requirement table 121.

In a step 1003, the policy generation program module 111 receives a process completion notice.

According to the abovementioned process, the management server 101 can store the requirement related to backup from the user in the user requirement table 121.

Further, the system administrator may also utilize to register the information in the IT infrastructure table 127 by replacing the user in the step 1001 with the system administrator and replacing the user requirement table 121 in the step 1002 with the IT infrastructure requirement table 127. In this case, the management server 101 acquires the respective information of the target system/equipment 502, the sub-requirement ID 503, the requirement type 504 and the contents of the user requirement 505 in relation to the system requirement ID 501.

FIG. 11 is a flowchart showing one example of a process executed by the policy generation program module 111 of the management server 101. The policy generation program module 111 generates a policy on the basis of the IT infrastructure requirement table 127 and the user requirement table 121 in generating the policy, however, at that time, the policy generation program module checks whether or not a user requirement equivalent to the user requirement type stored in the column 507 exists in the user requirement table 121 (a step 1104 described later), and when the corresponding user requirement exists in the user requirement table 121, the policy generation program module generates the policy with the corresponding system requirement and the user requirement combined (a step 1105 described later). For example, in the column 507 on lines of the sub-requirement 1-4 of the system requirement 1 shown in FIG. 5 in the first embodiment, RPO is stored as the user requirement type and in the column 405 on lines of the sub-requirement 1-1 of the user requirement 1 in the user requirement table 121, RPO is also stored. In this case, the policy 1 shown in FIG. 6 is generated on the basis of the respective information of the sub-requirement 1-4 of the system requirement 1 and the sub-requirement 1-1 of the user requirement 1. As for the user requirement type, the IT infrastructure administrator judges whether the user requirement type is related to the system requirement or not when the IT infrastructure administrator designs the user requirement and stores the user requirement type. Further, since no user requirement combined in generating a policy exists when no user requirement type is written in the column 507, the policy generation program module 111 interprets only the system requirement and generates a policy (a step 1106 described later). Moreover, regarding the sub-requirement related to no sub-requirement of any system requirement out of the sub-requirements in the user requirement table, since no system requirement combined in generating a policy exists, the policy generation program module 111 interprets only the user requirement and generates a policy (a step 1108 described later). Hereinafter, a process flow by the policy generation program module 111 will be described.

In a step 1101, the policy generation program module 111 is notified of the execution of a requirement input process and the completion of the process from the requirement acquisition program module 114.

In a step 1102, the policy generation program module 111 refers to the user requirement table 121, the IT infrastructure requirement table 127 and the shared resource table 123.

In a step 1103, the policy generation program module 111 evaluates all the sub-requirements of the system requirement to judge whether or not the respective sub-requirements of the system requirement in the IT infrastructure requirement table 127 are related to the sub-requirements of the user requirement in the user requirement table 121 in generation a policy. That is, the processing in the steps 1104 to 1106 is repeated for the sub-requirements.

In the step 1104, it is evaluated whether or not the same information as the requirement type (in the column 507) of the sub-requirement of the system requirement in the IT infrastructure table 127 is stored in the requirement type (in the column 405) of the sub-requirement of the user requirement in the user requirement table 121. When the same information as the requirement type (in the column 507) of the sub-requirement of the system requirement in the IT infrastructure table 127 is stored in the requirement type (in the column 405) of the sub-requirement of the user requirement in the user requirement table 121, processing proceeds to the step 105. In a case except it, the processing proceeds to the step 1106.

In the step 1105, the policy generation program module 111 generates a policy using the sub-requirement of the system requirement, the sub-requirement of the user requirement and information of the shared resource table 123 and stores the policy in the policy table 128. Next, the processing proceeds to a step 1107.

In the step 1106, the policy generation program module 111 generates a policy using the sub-requirement of the system requirement and information of the shared resource table 123 and stores the policy in the policy table 128. The processing proceeds to the step 1107. As the details of generating the policy are described in relation to the policy table shown in FIGS. 6A and 6B, they are omitted.

In the step 1107, it is evaluated whether or not the user requirement related to no sub-requirement of any system requirement in the step 1103 exists. When the user requirement related to no sub-requirement of any system requirement exists, the processing proceeds to the step 1108. In a case except it, the processing proceeds to a step 1109.

In the step 1108, the policy generation program module 111 generates a policy every sub-requirement of all the sub-requirements of the user requirement evaluated in the step 1107 and related to no sub-requirement of any system requirement and stores the policy in the policy table 128. The processing proceeds to the step 1109.

In the step 1109, the schedule adjustment program module 113 is notified of the completion of the process.

The management server 101 generates the policy for adjusting a backup schedule by the abovementioned process and can store the policy in the policy table 128.

FIGS. 12A, 12B and 12C are a flowchart showing one example of a process executed by the schedule adjustment program module 113 in the management server 101. In this process, the management server 101 changes the schedule table 125 including identification information of the backup object equipment and backup execution time in accordance with usage status of the backup object equipment and a situation of the system such as the storage device to execute the backup of plural management object equipment and adjusts a schedule.

In a step 1201, the schedule adjustment program module 113 refers to the shared resource table 123, the backup information table 129, the policy table 128 and the schedule table 125.

In a step 1202, the schedule adjustment program module 113 changes the backup adjustment flag of the task the execution result of which is unexecuted to “unexecuted”, out of the tasks in the schedule table 125.

In a step 1203, the order of the task the backup of which is unexecuted in the schedule table 125 is rearranged. The tasks are arranged in earlier order in the execution time of the task and besides, when the execution time is the same, the task having higher precedence in the column 804 in the schedule table 125 is entered in advance.

In a step 1204, the schedule adjustment program module 113 starts loop processing of the tasks having the task execution result of “unexecuted” in the column 806 in the schedule table 125 in order in which the tasks are entered in the schedule table 125. This loop processing is repeated until the adjustment flags of all the backup tasks are changed to “adjusted”.

In a step 1205, the schedule adjustment program module 113 refers to the applied policies in the backup information table 129. At this time, the applied policies are judged from backup information in which the ID of the backup object in the column 802 in the schedule table 125 and the node ID in the backup information table 129 coincide.

In a step 1206, the schedule adjustment program module 113 judges whether the schedule of the backup task meets the policy 1 in the policy table 128 or not. For example, as a differential since the last backup time till the next backup time is 120 minutes when the last backup time of VM2 is 2013/1/1 9:00 and the next task of VM2 is 2013/1/1 11:00, the backup schedule of VM2 meets the policy 1. If the task of VM2 is 2013/1/1 10:00, a backup interval is 60 minutes and the policy 1 is not met. When the policy 1 is met, processing proceeds to a step 1208. When the policy 1 is not met, the processing proceeds to a step 1207. In this embodiment, since the example of the application of the policy to VM1 and VM2 is shown, the policy 1 is given for an example, however, when the policy is different like VM3 and another VM, processing is executed as the policy 5 equivalent to the policy 1 (the policy attribute ID is the same) for VM3.

In the step 1207, the schedule adjustment program module 113 changes the execution time of the next backup task so that the policy 1 is met. For example, since the policy 1 is not met when the last backup time of VM2 is 2013/1/1 9:00 and the next task of VM2 is 2013/1/1 10:00, the execution time of the next task of VM2 is changed to 2013/1/1 11:00.

In this embodiment, the policy 1 is described for an example, however, when this processing is executed as to another VM, the policy the policy attribute ID of which is 1 in FIG. 6A or 6B is applied.

In the step 1208, the schedule adjustment program module 113 judges whether the schedule of the backup task meets the policy 2 in the policy table 128 or not. For example, when the management server 101 stores backup data of VM2 in the resource pool having restore performance of 125 MB (written to the shared resource table 123) per minute, the management server 101 is required to inhibit the backup data to 500 MB or less to enable such backup that the policy 2 is met. When the policy 2 is met, the processing proceeds to a step 1210. When the policy 2 is not met, the processing proceeds to a step 1209. In this embodiment, since the example of the application of the policy to VM1 and VM2 is shown, the policy 2 is given for an example, however, when the policy is different like VM3 and another VM, evaluation is made as the policy 6 equivalent to the policy 2 (the policy attribute ID is the same) for VM3.

In the step 1209, the execution time of the next backup task is changed to meet the policy 2. For example, since the policy 2 is not met unless backup is executed until 200 MB acquired by subtracting 300 MB of the current incremental quantity of backup data from 500 MB is consumed as backup data in a case where it is known from the column 907 in the backup information table 129 that there is the accumulation of backup data for 300 MB at that time when the last backup of VM2 is 2013/1/1 17:00, it can be estimated, on the basis of information that mean consumed resource capacity of VM2 is 200 MB per hour in the column 905 in the backup information table 129, that time in which 200 MB is consumed is 60 minutes. Therefore, the backup task is required to be executed before 2013/1/1 18:00 so that the backup task of VM2 is executed within 60 minutes. Even if backup execution time is changed in the step 1207 so that a backup interval is 96 to 120 minutes, backup execution time determined in this step is overwritten to precede RTO which is a user requirement. Further, when the type of backup in the column 803 in the schedule table 125 is set to Snapshot, the precedent in the column 804 of full backup is changed to “high” and the supposed cumulative amount of backup data in the column 906 in the backup information table 129 is changed to 0. This reason is that time required for restoration can be reduced by eliminating a differential of cumulative backup data by full back. Next, the processing proceeds to the step 1210.

In this embodiment, the policy 2 is described for an example, however, when this process is executed by another VM, the policy having the policy attribute ID of 2 shown in FIG. 6A or 6B is applied.

In the step 1210, it is judged whether or not the schedule adjustment program module 113 meets the policy 3 in the policy table 128. Concretely, it is verified that 5 days or more elapses between acquisition time of the oldest backup data out of backup data stored in the backup data table 126 and acquisition time of the latest backup data. When the policy 3 is met, the processing proceeds to a step 1212. When the policy 3 is not met, the processing proceeds to a step 1211. As in FIG. 1, the example of the application of the policy to VM1 and VM2 is shown, the policy 3 is given for an example, however, when the policy is different like VM3 or another VM, evaluation is made as the policy 7 equivalent to the policy 3 (the policy attribute ID is the same) for VM3.

In a step 1211, the schedule adjustment program module 113 judges whether or not the backup retention period (for example, 5 days) or more elapses since backup initiation time of the backup object equipment. This reason is that it is judged on the basis of the policy 3 in the step 1210 whether backup data for the retention period exists or not; however, there is possibility that days for the backup retention period do not elapse since backup is set and backup data is started to be acquired. Since backup initiation time is written in the backup information table 129, it is judged whether the backup retention period elapses since that time or not. When time has not elapsed since the backup initiation time and backup data for the backup retention period does not exist, the processing proceeds to a step 1212. When backup data is deficient though the backup retention period or more elapses since the initiation of backup, the processing jumps to a step 1217.

In this embodiment, the policy 3 is described for an example, however, when this process is executed by another VM, the policy having the policy attribute ID of 3 and shown in FIG. 6A or 6B is applied.

In the step 1212, the schedule adjustment program module 113 judges whether the policy 8 in the policy table 128 is met or not. Concretely, the schedule adjustment program module compares the usage rate of the resource pool that stores backup data of the backup object equipment and the usage rate set in the policy 8. The usage rate of the resource pool is calculated on the basis of how much capacity of the maximum resource amount written to the column 706 in the shared resource table 123 a value acquired by summing the supposed resource consumption amount in the column 708 in the shared resource table 123 as a total value of resource consumption amounts when backup tasks the adjustment of which is finished at the current time of a schedule adjustment process are normally executed and the mean consumed backup data capacity in the column 905 in the backup information table 129 occupies. When the calculated usage rate of the resource pool is equal to or more than the usage rate written to the policy 8, the processing proceeds to a step 1214. When the usage rate of the resource pool is below the usage rate written to the policy 8, the processing proceeds to a step 1213.

In this embodiment, the policy 8 is described for an example, however, when this process is executed by another VM, the policy having the policy attribute ID of 4 and shown in FIG. 6A or 6B is applied.

In the step 1213, the schedule adjustment program module 113 judges whether the policy 9 in the policy table 128 is met or not. Concretely, the schedule adjustment program module judges whether or not the number of generations of Snapshots as the supposed resource consumption mount in the column 708 in the shared resource table 123 exceeds 800 generations. When the policy 5 is met, the processing proceeds to a step 1218. When the policy 9 is not met, the processing proceeds to a step 1225.

In the step 1214, the schedule adjustment program module 113 judges whether backup of backup data having the past retention period exists or not. For example, when the retention period of backup is 5 days, it is judged whether backup data except the latest backup data to backup data before 5 days exists or not. When the backup data exists, the processing proceeds to a step 1215. When no backup data exists, the processing proceeds to a step 1217.

In the step 1215, the schedule adjustment program module 113 deletes backup data except backup data in the minimum backup data retention period acquired in the step 1214.

In a step 1216, the schedule adjustment program module 113 updates the resource pool usage rate of the shared resource and generation number information.

In the step 1225, the schedule adjustment program module 113 executes the similar processing to that in the step 1214.

In a step 1226, the schedule adjustment program module 113 executes the similar processing to that in the step 1215.

In a step 1227, the schedule adjustment program module 113 executes the similar processing to that in the step 1216.

In this embodiment, the policy 9 is described for an example, however, when this process is executed by another VM, the policy having the policy attribute ID of 5 and shown in FIG. 6A or 6B is applied.

In the step 1217, the schedule adjustment program module 113 contacts the IT infrastructure administrator because resources for backup are deficient or backup cannot be correctly retained.

In a step 1218, the schedule adjustment program module 113 judges whether it is time when the backup object equipment is operated in executing the next backup or not. Concretely, the schedule adjustment program module judges whether or not the backup object equipment is operated at the execution time of the next backup task, referring to the operation schedule in the backup information table 129. That is, the schedule adjustment program module makes judgement related to the policy 4. When the execution time of the next backup task is in the operation schedule, the processing proceeds to a step 1221. When the execution time of the next backup task is out of the operation schedule, the processing proceeds to a step 1219.

In the step 1219, the schedule adjustment program module 113 judges whether or not backup tasks are stacked for the acquisition of backup in a state in which the backup object equipment is not operated (halted). The reason why backup is executed in the unoperated state is that no backup data of the backup object equipment in the unoperated state exists when backup is omitted in accordance with the operation schedule and when backup data out of the operation schedule time is required, the backup data cannot be provided. It is judged on the basis of information in the column 908 in the backup information table 129 whether or not a schedule is made so that backup is acquired in a state in which the backup object equipment is not operated (halted). When backup is acquired in the state in which the backup object equipment is not operated (halted), the processing proceeds to a step 1220. If not, the processing proceeds to a step 1219.

In the step 1220, the schedule adjustment program module 113 deletes the task in the schedule table 125 from the table. This means that as the backup task stored as it is out of the operation schedule, the execution of backup is canceled.

In the step 1221, an estimated consumption amount of the backup resource while the backup task currently adjusts is calculated on the basis of the mean consumed backup data capacity in the column 905 in the backup information table 129 and is added to a field of the supposed resource consumption amount in the column 708 in the shared resource table 123.

In a step 1222, the schedule adjustment program module 113 changes a value of the adjustment table in the column 807 in the schedule table 125 to “executed”.

When backup adjustment flags of all the tasks to which “unexecuted” is written in the column 804 of the task execution result in the schedule table 125 are changed to “adjusted”, a loop is terminated and the process is completed.

In a step 1223, values of the supposed resource consumption amount in the column 708 in the shared resource table 123 and values of the supposed backup data cumulative amount in the column 907 in the backup information table 129 are initialized. Initialization means that for the former, the same values as values of the current resource consumption amount in the column 707 in the shared resource table 123 are written and that for the latter, the same values as values of the current backup data cumulative amount in the column 906 in the backup information table 129 are written.

The management server 101 can adjust a schedule of backup by these processing.

An example that the management server 101 executes the process shown in FIGS. 12A, 12B and 12C on the basis of the policies set for VM1, VM2, VM3 will be described below. For a characteristic of this embodiment, the management server 101 classifies the policy of each VM with the policy attributes shown in FIGS. 6A and 6B and executes processing of each policy shown in FIGS. 12A, 12B and 12C according to the policy attributes. Concretely, in FIGS. 12, the policies respectively having the policy attribute ID of 1, 2, 3, 4, 5, 6 are written to items to which the policies 1, 2, 3, 4, 8, 9 are respectively written, the management server 101 executes the corresponding processing every task on the basis of the policy attribute, and the management server generates a backup schedule.

FIG. 13 is a flowchart showing one example of a process executed by the operating information monitoring program module 112 of the management server 101. In this process, operating information of the management object equipment such as the server 106 and the virtual server 167 managed by the management server 101 and a usage state of resources are acquired. When the operating information monitoring program module 112 acquires an operating state from the management object equipment, it may also regularly acquire according to a time interval statically set by the administrator of the system, the program module may calculate a backup interval of the management object equipment on the basis of the backup schedules in the schedule table 125 and the conditions in the policy table 128, and the program module may also regularly acquire information at a time interval shorter than the backup interval. Further, when modification of configuration information of the management object equipment by the management server 101 is detected and a resource consumption amount reaches a predetermined threshold, it is set that an alert should be issued from the management object equipment to the management server 101, the operating information monitoring program module 112 of the management server 101 may also acquire information with it as a trigger, and information may also be acquired in a link with another management software that monitors the same equipment. Moreover, for example, an operating state of the virtual server 167 may also be acquired from virtualization base OS upon which the virtual server 167 is based.

In a step 1301, the operating information monitoring program module 112 refers to the equipment information table 122, the shared resource table 123 and the backup information table 129. At this time, the operating information monitoring program module 112 acquires authentication information for accessing the target equipment the information of which is to be acquired and others.

In a step 1302, the operating information monitoring program module 112 accesses the target equipment the information of which is to be acquired and acquires information such as operating information of the equipment and a usage state of resources.

In a step 1303, it is checked whether or not the backup objects stored in the backup information table are activated over normal operating time. When the backup object is activated over the operating time, processing proceeds to a step 1304.

In the step 1304, to immediately apply backup to the backup object activated over the operating time, a backup task corresponding to the backup object is registered in the schedule table. Further, adjustment of the schedule is requested the schedule adjustment program module 113.

In a step 1305, the operating information monitoring program module 112 stores acquired information in the equipment information table 122 and the shared resource table 123.

This processing enables the management server 101 to acquire the latest information of the backup object equipment required in adjusting a schedule of backup and the latest information of resources shared by the backup object equipment.

FIG. 14 is a flowchart showing one example of a process executed by the backup instruction unit 131. In this process, backup processing is executed for the management object equipment such as the virtual server 167 managed by the management server 101 at task execution time written to the backup task in the schedule table 125.

In a step 1401, the backup instruction unit 131 refers to the schedule table 125.

In a step 1402, the backup instruction unit instructs the storage device 150 to execute backup processing according to the task written to the schedule table 125. When backup succeeds, backup data is stored in the backup table 126.

In a step 1403, a completion notice of backup instructed for the storage device 150 in the step 1402 is detected.

In a step 1404, it is judged on the basis of the completion notice of backup detected in the step 1403 whether backup succeeds or not. When the backup succeeds, processing proceeds to a step 1406. When the backup fails, the processing proceeds to a step 1405.

In the step 1405, the IT infrastructure administrator and the user are notified of the failure of backup. In FIG. 14, when the backup fails, the IT infrastructure administrator and the user are notified, however, backup processing may also be retried for the same management object equipment using the failure of backup processing for a trigger.

In the step 1406, information such as status information that the backup task in the schedule table 125 and executed in the step 1402 succeeds and a backup resource consumption amount consumed when backup is executed in the step 1402 is input.

This process enables the management server 101 to actually execute backup for the management object equipment and to judge whether the backup succeeds or not.

FIG. 15 shows one example of a graphical user interface (GUI) used when the user inputs a backup requirement to the management server 101.

This GUI is used when the user inputs setting of backup to the management server 101 after the user prepares the virtual server 167 and others to newly construct a business system.

This GUI may also be displayed on an input terminal (not shown) connected to the management server 101 and similar GUI may also be displayed by an application program linked with the management server 101.

A GUI screen 1501 denotes a screen for setting backup. This screen may also be automatically displayed after it is detected that the virtual server 167 is newly provisioned in the management server 101 for example, the similar screen may also be prepared as a wizard screen for provisioning when the management server 101 provides a wizard for provisioning the virtual server 167, and the similar screen may also be displayed successively afterward.

Further, when the management server 101 performs backup setting for the equipment already managed by the management server, the management server 101 outputs a list of management objects to the GUI (not shown) before the GUI screen 1501 is displayed, equipment the backup of which is to be set is selected from the list of management objects, and the selected equipment may also be displayed on the GUI screen 1501.

A text box 1502 is provided for the user to input information for identifying the equipment the backup of which is to be set. The user is not required to newly input by selecting the equipment the backup of which is to be set on the GUI screen of the management server 101 and others as described above.

Text boxes 1503 to 1505 are provided to input information of a backup requirement. In this embodiment, the user can input time for RPO into the text box 1503. The user can input time for RTO into the text box 1504. In the text box 1505, a period in which data backed up by the management server 101 is retained in the backup resource pool 158 in the storage device 150 is input. In this embodiment, only RPO, RTO and the backup retention period are described, however, the IT infrastructure administrator may also input another requirement if necessary.

A button 1506 applies the backup requirement to the backup object on the GUI screen 1501.

A button 1507 terminates the setting of backup without applying the backup requirement to the backup object on the GUI screen 1501.

The user can input the information of the backup object and the requirement in backup to the management server 101 by this process.

FIG. 16 shows the backup data table 126.

The backup data table 126 includes backup data of backup object equipment.

A column 1601 stores ID for uniquely identifying the backup object equipment.

A column 1602 stores ID for the management server 101 to uniquely identify the backup data. The input of data stored in the column 1601 can be omitted by designating any of each column used in this table 126 or combined plural columns. Further, the backup data ID may also be automatically allocated in ascending order and others by the management server 101.

A column 1603 shows capacity of a resource used by each backup data. ID for uniquely identifying a system and equipment to be backed up is stored. The node ID and others are stored as the ID.

A column 1604 shows time at which each backup data is acquired.

A column 1605 stores each backup data.

According to the first embodiment, the management server 101 generates a suitable backup acquisition schedule according to a situation of the backup object equipment and can execute backup by only inputting a backup requirement for the equipment to be backed up for the user (the tenant manager 200). Further, a load of the IT infrastructure administrator in system architecture in environment in which multiple VMs exist and a cost can be also reduced.

FIG. 17 shows one example of a process for adjusting a backup schedule when the method of adjusting the backup schedule in the first embodiment is applied in environment in which backup schedules of a group of servers are made on the basis of the same backup setting.

For a method of provisioning VM and the physical server, a golden image including OS, a business application program, middleware and others is prepared, a method of performing specific customization every VM and every physical server after the golden image is copied and a method such as VDI (Virtual Desktop Infrastructure) in which plural VMs seem to be provisioned by preparing one golden image and an area for storing different information among each VM (user information, information of the application program and others) in the case of virtual environment can be given.

A large number of VMs and servers can be once provisioned by using the two provisioning methods, however, as to backup setting based upon a user requirement different among each VM and others, user requirements are copied like the golden image, the completely same backup setting is applied to each VM and each server, as a result, convenience is resigned or great labor is expended, and backup setting is required to be adjusted one by one.

A box 1701 shows a schedule before the method of adjusting a backup schedule in the first embodiment is applied. As the backup schedule is made on the basis of the same backup setting, backup is executed in parallel in the same time zone. In such a case, a large load is applied to the IT infrastructure at a fixed interval. Further, capacity of the resource pool, the number of generations of Snapshots and others are quickly consumed by equally acquiring the backup of all VMs at the fixed interval.

A box 1702 shows a schedule after the method of adjusting the backup schedule according to the present invention is applied. For example, when the business system can be recovered within three hours in VM1, can be recovered within two hours in VM2 and can be recovered within one hour in VM3 as to RPO out of the user requirements, backup tasks for VM1 to VM3 are stacked at an interval of one hour so as to achieve RPO of VM3 severe for a user requirement in the backup schedule in the box 1701, and excessive backup is executed for VM1. In such a case, a frequency of backup can be also reduced by reconfiguring a backup schedule according to the policy in the first embodiment.

As described above, the user is not required to perform backup setting such as registering a backup schedule in individual VM and an individual server after provisioning and deleting unnecessary backup by using the method of adjusting the backup schedule in the first embodiment.

### Second Embodiment

In the first embodiment, the management server 101 adjusts and creates a backup schedule on the basis of a user requirement, a system requirement and others. In a second embodiment, a difference between the already registered backup schedule and the backup schedule adjusted and created in the first embodiment is clarified to a user by comparing the already registered backup schedule and the backup schedule adjusted and created in the first embodiment or making the user output a differential before/after the adjustment of the backup schedule to accessible output destinations. The designed backup schedule includes a backup schedule designed by the user.

FIG. 18 shows one example of a graphical user interface (GUI) when a management server 101 newly recommends a backup schedule for the user.

This GUI compares a backup schedule designed by the user with a backup schedule after the management server 101 adjusts the backup schedule and recommends the latter.

This GUI may also be displayed on an input terminal (not shown) connected to the management server 101 and the similar GUI may also be displayed by an application program linked with the management server 101.

A GUI screen 1801 denotes a screen for comparing backup schedules. For this screen, for example, the management server 101 detects that a virtual server 167 is newly provisioned and may also automatically display the screen, the similar screen may also be prepared as a wizard screen for provisioning when the management server 101 provides a wizard for provisioning the virtual server 167, and the similar screen may also be displayed successively afterward.

Information for identifying equipment which is an object of a backup schedule is input to a text box 1802.

A text box 1803 shows the user how much expense (a cost required for an IT infrastructure) is reduced by comparing a backup schedule after the management server 101 adjusts a backup schedule with a backup schedule designed by the user. The management server 101 calculates a cost on the basis of a resource consumption amount required for backup per once and a frequency of backup. The management server 101 accepts the input from an IT infrastructure administrator of information of ¥1000/1 GB for a resource pool usage charge as to a resource pool 1 and of ¥100 per backup as to a backup usage charge for example via an input device 105, and the management server stores the information in tables (not shown) in the management server 101. When costs are calculated, the management server 101 calculates by multiplying “mean consumed resource capacity” in a column 905 in a backup information table shown in FIG. 9 and “the number of backup points in a backup schedule”.

A GUI screen 1804 shows the user whether or not backup tasks are reduced by comparing backup schedules before/after adjustment such as a backup schedule after the management server 101 adjusts a backup schedule and a backup schedule designed by the user.

A button 1805 is provided to determine the application of a backup schedule recommended in the GUI screen 1803.

A button 1806 is provided to cancel the application of the backup schedule recommended in the GUI screen 1803.

The user can input information of an object to be backed up and a requirement in executing backup to the management server 101 by this process.

FIG. 19 shows a user designed schedule table 1900. This shows a backup schedule designed by the user beforehand.

A column 1901 stores ID for the management server 101 to uniquely identify a user designed task. The input of data stored in the column 1901 can be omitted by designating any of each column used in this table 130 or combined plural columns. Further, the user designed task ID may also be automatically allocated in ascending order and others by the management server 101.

A column 1902 stores ID for identifying equipment to be backed up. For the ID, node ID and others are stored.

A column 1903 shows a type of backup in executing backup. In FIG. 19, although only backup depending upon Snapshots is described, another backup method may also be used.

In a column 1904, time scheduled to execute a backup task or time when a backup task is executed is stored.

In the second embodiment, it is clarified that the efficiency of schedules of the former is more satisfactory than the efficiency of schedules of the latter when the existing schedule table 125 and the user designed schedule table 1900 are compared and it is displayed on the screens shown in FIG. 18.

### Third Embodiment

In a third embodiment, technique for a management server 101 to merge separate user requirements, to create a new user requirement, to generate a common policy on the basis of the new user requirement and an IT infrastructure requirement and to adjust a backup schedule using the common policy when a user imposes a separate different requirement on each of plural servers that share a resource will be described. A backup schedule common to the plural VMs shown in 1701 in FIG. 17 may also be generated on the basis of the technique. System configuration is the same as that in the first embodiment except that a backup setting merging program module 2001 is stored in a memory of the management server 101.

FIG. 20 is a flowchart showing a process by the backup setting merging program module 2001.

In a step 2002, the backup setting merging program module 2001 refers to a user requirement table 121 and a shared resource table 123.

In a step 2003, the backup setting merging program module 2001 searches plural management objects different in user requirements though the objects share a resource and selects the plural management objects found as a result.

In a step 2004, the backup setting merging program module 2001 selects the most severe requirement as an item out of user requirements linked with the selected management objects. For example, when “a business system can be recovered into a state before 3 hours at the time of the occurrence of failure” which is the requirement of RPO for VM4 and “a business system can be recovered into a state before 2 hours at the time of the occurrence of failure” which is the requirement of RPO for VM5 are compared in a case where VM4 and VMS respectively shown in FIG. 4 are selected in the step 2002, the requirement for VM5 is more severe than the requirement for VM4 because the requirement for VM5 is closer to time of recovery than the requirement for VM4. Therefore, for RPO, the requirement for VM5 is selected. That is, in the case of RPO, RPO closest to time at which recovery of VM is requested since the occurrence of failure is selected out of conditions related to RPO of VMs that share a resource by processing for recovery based upon backup.

Similarly in the case of RTO, the shortest RTO in time required for processing for recovery based upon backup is selected out of conditions related to RTO of VMs that share a resource.

Further, in the case of a backup retention period, the longest retention period is selected out of conditions related to a backup retention period of VMs that share a resource.

In a step 2005, a new user requirement is newly created on the basis of respectively selected items in the step 2003.

In a step 2006, the user requirement newly created in the step 2005 is registered in a user requirement table 121.

In a step 2007, a common policy is generated on the basis of the user requirement newly created in the step 2005, a system requirement in an IT infrastructure requirement table 127 and information in the shared resource table 123. As a method of generating the common policy is similar to the generation of the policy in the first embodiment, the details are omitted.

In a step 2008, a common backup schedule is generated on the basis of the common policy and an operating state of equipment. As a method of generating the common backup schedule is similar to the generation of the policy in the first embodiment, the details are omitted.

In a step 2009, a backup schedule is generated using a policy which is generated on the basis of a user requirement and which is not the common policy. As the policy and the backup generation method are similar to the generation of the policy and the generation of the backup schedule in the first embodiment, the details are omitted.

In a step 2010, the common backup schedule and the backup schedule generated in the step 2009 are compared and unnecessary backups in the common backup schedule are selected.

In a step 2011, the backups (the tasks) judged unnecessary in the common backup schedule in the selection in the step 2011 are deleted.

As described above, in the third embodiment, the common policy which is a common policy to the VMs that share the resource is generated on the basis of the registered new user requirement and the IT infrastructure requirement (the step 2007) and the common backup schedule which is a common backup schedule to the VMs that share the resource is generated on the basis of the common policy (the step 2008).

The common backup schedule is set as respective initial backup schedules of VMs, to meet the policy every VM (also including every VM common in the user requirement) generated in the first embodiment 1 out of backups in the common backup schedule, required backups and unnecessary backups are selected (the step 2010), and the unnecessary backups are deleted from the respective common backup schedules (the step 2011).

As described above, a strict common backup schedule can be generated by generating the backup schedule common to plural VMs according to the policy based upon user requirements of the plural VMs in comparison with a case where backup setting in a golden image is merely copied. The common backup schedule may also be utilized for a backup schedule as it is.

Further, a backup schedule in which a load of the user, a load of the system and a load of the IT infrastructure administrator are reduced can be generated by further adjusting the common backup schedule on the basis of the policy of individual VM.

### LIST OF REFERENCE SIGNS

101: Management server, 102: Memory, 103: CPU, 104: Management interface, 105: I/O device, 130: Backup server, 150: Storage device, 152: Memory, 156: Storage unit, 154: CPU, 160: Server, 163: Memory, 164: CPU,

1. A method of adjusting a backup schedule for indicating scheduled time at which backup of a virtual computer out of a plurality of virtual computers managed by a management computer is to be executed,
wherein the management computer executes:
a first step of generating a policy on the basis of user condition information which includes a condition that limits time in a process for recovering the virtual computer on the basis of the backup and the input of which is accepted on the basis of first authority, and IT infrastructure condition information which includes a condition that limits a consumption amount of resources allocated to the virtual computer and the input of which is accepted on the basis of second authority different from the first authority; and
a second step of adjusting a backup schedule of the virtual computer on the basis of the policy and operating information showing an operating state of the virtual computer.

2. The method of adjusting the backup schedule according to claim 1,
wherein the management computer executes:
a third step of judging whether or not information which correlates the condition that limits the resource consumption amount and the condition that limits time and which shows a type of the condition that limits the time is correlated with the condition that limits the resource consumption amount in the first step;
a fourth step of generating a policy on the basis of the condition that limits time and the condition that limits the resource consumption amount when the information showing the type is correlated in the third step; and
a fifth step generating a policy on the basis of the condition that limits the resource consumption amount when the information showing the type is not correlated in the third step.

3. The method of adjusting the backup schedule according to claim 2,
wherein the management computer executes:
a sixth step of calculating resource consumption amounts based upon the backup before/after the adjustment of the backup schedule in the second step and frequencies of backup before/after the adjustment of the backup schedule in the second step; and
a seventh step of calculating a difference in cost before/after the adjustment of the backup schedule in the second step on the basis of the resource consumption amounts calculated in the sixth step and the frequencies of backup calculated in the sixth step and outputting the difference to an accessible output device of a user.

4. The method of adjusting the backup schedule according to claim 3,
wherein the management computer executes:
an eighth step of providing a common backup schedule that is a backup schedule common to the respective plurality of virtual computers that share the resources;
a ninth step of selecting unnecessary backups from the common backup schedule on the basis of the respective policies generated in the first step of the plurality of virtual computers so as to meet the respective policies of the plurality of virtual computers; and
a tenth step of deleting the unnecessary backups from the respective common backup schedule.

5. The method of adjusting the backup schedule according to claim 4,
wherein the management computer executes:
an eleventh step of selecting a first condition in which the time of a process for recovering the virtual computer on the basis of backup is the shortest out of user condition information of the plurality of virtual computers that share the resources; and
a twelfth step of generating the common backup schedule on the basis of the first condition.

6. A computer system including a plurality of virtual computers which is a virtual computer generated on the basis of resources of a computer and a management computer that manages a backup schedule indicating scheduled time at which backup of the virtual computer is to be executed,
wherein the management computer generates a policy on the basis of user condition information which includes a condition that limits time in a process for recovering the virtual computer on the basis of the backup and the input of which is accepted on the basis of first authority, IT infrastructure condition information which includes a condition that limits a resource consumption amount of resources allocated to the virtual computer and the input of which is accepted on the basis of second authority different from the first authority, and information which correlates the condition that limits the resource consumption amount and the condition that limits time and which shows a type of the condition that limits time; and
the backup schedule of the virtual computer is adjusted on the basis of the policy and operating information showing an operating state of the virtual computer.

7. The computer system according to claim 6,
wherein the management computer:
judges whether or not the information showing the type is correlated with the condition that limits the resource consumption amount;
generates a policy on the basis of the condition that limits time and the condition that limits the resource consumption amount when the information showing the type is correlated; and
generates a policy on the basis of the condition that limits the resource consumption amount when the information showing the type is not correlated.

8. The computer system according to claim 7,
wherein resource consumption amounts based upon backup before/after the adjustment of the backup schedule and frequencies of backup before/after the adjustment of the backup schedule in the second step are calculated; and
a difference in cost of a backup schedule before/after the adjustment of the backup schedule is calculated on the basis of the calculated resource consumption amounts and the calculated backup frequencies, and the difference is output to an accessible output device of a user.

9. The computer system according to claim 8,
wherein the management computer:
provides a common backup schedule common to the respective plurality to virtual computers that share the resources;
selects unnecessary backups from the common backup schedule on the basis of the policies generated for the respective plurality of virtual computers so as to meet the respective policies of the plurality of virtual computers; and
deletes the unnecessary backups from the common backup schedule.

10. The computer system according to claim 9,
wherein the management computer:
selects a first condition in which the time of a process for recovering the virtual computer on the basis of backup is the shortest out of user condition information of the plurality of virtual computers that share the resources; and
generates the common backup schedule on the basis of the first condition.
